(19) United States
(12) Patent Application Publication
(10) Pub. No.: US 2014/0093821 A1
(43) Pub. Date: Apr. 3, 2014

(54) LIQUID DEVELOPER AND METHOD OF PRODUCING LIQUID DEVELOPER

(71) Applicants: Shin-Etsu Chemical Co., Ltd., Tokyo (JP); SEIKO EPSON CORPORATION, Tokyo (JP)

(72) Inventors: Tsutomu TERAOKA, Nagano (JP); Fuminori YANO, Nagano (JP); Masanao KAMEI, Gunma (JP)

(73) Assignees: Shin-Etsu Chemical Co., Ltd., Tokyo (JP); SEIKO EPSON CORPORATION, Tokyo (JP)

(21) Appl. No.: 14/036,876

(22) Filed: Sep. 25, 2013

(30) Foreign Application Priority Data
Sep. 28, 2012 (JP) 2012-218630

(51) Int. Cl. G03G 9/13; G03G 9/08

(52) U.S. Cl. CPC G03G 9/132; G03G 9/0804
USPC 430/114; 430/137.19

(57) ABSTRACT

A method of producing a liquid developer containing an insulation liquid and toner particles is provided. The method includes: grinding a toner material under the presence of a substance A in the insulation liquid; subjecting a dispersion liquid to a heat treatment at a higher temperature than a glass transition temperature of a resin material while giving shear force to the dispersion liquid: and mixing the dispersion liquid having been subjected to the heat treatment with a substance B. A liquid developer including an insulation liquid, toner particles, and a substance B is also provided. The toner particles are constituted of a substance A, a resin material and a coloring agent. The resin material is a polyester resin and/or a styrene-acrylic resin. The substance A is an acrylic modified silicone sufficiently soluble to the insulation liquid and the substance B is a silanol group-containing polysiloxane and/or a fluorine modified silicone.

### CROSS-REFERENCE TO RELATED APPLICATION

This application claims priority to Japanese Patent Application No. 2012-218630 filed on Sep. 28, 2012 which is hereby expressly incorporated by reference herein in the entirety.

### BACKGROUND

1. Technical Field

The present invention relates to a liquid developer and a method of producing the liquid developer.

2. Related Art

As a developer used for developing an electrostatic latent image formed on a latent image carrier, a liquid developer is known. Such a liquid developer is obtained by dispersing toner particles in a carrier liquid (an insulation liquid) having electric insulation properties. The toner particles are formed of a material containing a coloring agent such as a pigment or the like and a binder resin.

Conventionally, a resin material such as a polyester resin, a styrene-acrylic ester copolymer and an epoxy resin or the like is used as a material for constituting the toner particles used for such a liquid developer (referred to Patent Document 1). The toner particles containing such a resin material are easy to handle. Further, in the developing method using the liquid developer containing the toner particles, it is possible to produce an image having good color development with high fixing characteristics.

However, the resin material used as a constituting material of the toner particles, generally, has negative charge characteristics in itself. Therefore, it is difficult to use such a resin material for positively charged toner particles (liquid developer). Furthermore, even if the toner particles obtained by using such a resin material are positively charged by a charge controlling agent, it is difficult to obtain a sufficient charge amount.

The Patent Document 1 is JP A-2007-219380 which is an example of related art.

### SUMMARY

Accordingly, it is an object of the present invention to provide a method of producing a liquid developer which is capable of efficiently producing the liquid developer having excellent positive charge characteristics and excellent crushability of a toner material. Further, it is another object of the present invention to provide a liquid developer that has the excellent positive charge characteristics.

These objects are achieved by the present invention described below.

In a first aspect of the invention, there is provided a method of producing a liquid developer containing an insulation liquid, toner particles, and a substance B, wherein the toner particles are constituted of a substance A and a toner material including a resin material and a coloring agent, and

wherein the resin material is a polyester resin and/or a styrene-acrylic resin, the substance A is an acrylic modified silicone sufficiently soluble to the insulation liquid and the substance B is a silanol group-containing polysiloxane and/or a fluorine modified silicone, the method comprising:

grinding the toner material under the presence of the substance A in the insulation liquid to obtain a dispersion liquid in which fine particles are dispersed;

subjecting the dispersion liquid to a heat treatment at a higher temperature than a glass transition temperature of the resin material while adding shear force to the dispersion liquid: and

mixing the dispersion liquid having been subjected to the heat treatment with the substance B to obtain the liquid developer containing the toner particles comprised of the fine particles.

This makes it possible to provide the method of producing the liquid developer which is capable of efficiently producing the liquid developer having excellent positive charge characteristics. Further, it is also possible to obtain excellent dispersion stability of the toner particles in the liquid developer.

In the first aspect of the present invention, there is provided a method of producing a liquid developer containing an insulation liquid, toner particles, and a substance B, wherein the toner particles are constituted of a substance A and a toner material including a resin material and a coloring agent, and

wherein the resin material is a polyester resin and/or a styrene-acrylic resin, the substance A is an acrylic modified silicone sufficiently soluble to the insulation liquid and the substance B is a silanol group-containing polysiloxane and/or a fluorine modified silicone, the method comprising:

grinding the toner material under the presence of the substance A and the substance B in the insulation liquid to obtain a dispersion liquid in which fine particles are dispersed; and

subjecting the dispersion liquid to a heat treatment at a higher temperature than a glass transition temperature of the resin material while adding shear force to the dispersion liquid to obtain the liquid developer containing the toner particles comprised of the fine particles.

This makes it possible to provide the method of producing the liquid developer which is capable of efficiently producing the liquid developer having excellent positive charge characteristics. Further, it is also possible to obtain excellent dispersion stability of the toner particles in the liquid developer.

In the method of the liquid developer according to the invention, it is preferred that the substance A is an acrylic modified silicone in which radical polymerization monomers are copolymerized.

This makes it possible to obtain the excellent dispersion stability of the toner particles in the liquid developer while making the toner particles have excellent charge characteristics. Further, it is possible to obtain the liquid developer having excellent development and transfer characteristics.

In the method of the liquid developer according to the invention, it is also preferred that the radical polymerization monomers have polar groups.

This makes it possible to obtain the excellent dispersion stability of the toner particles in the liquid developer while making the toner particles have the excellent charge characteristics.

In the method of the liquid developer according to the invention, it is also preferred that the polar groups of the radical polymerization monomers are amino groups.

This makes it possible to obtain the excellent dispersion stability of the toner particles in the liquid developer while making the toner particles have further excellent charge characteristics.

In the method of the liquid developer according to the invention, it is also preferred that the substance A is an acrylic modified silicone in which silicone macromeres represented by the following general formula (1) are copolymerized:

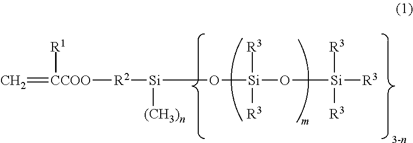

where R¹ is a hydrogen atom or a methyl group, R² is a bivalent hydrocarbon group having a carbon number in the range of 1 to 5, R³ is a hydrocarbon group having a carbon number in the range of 1 to 3, an aryl group or a fluorine-substituted hydrocarbon group having a carbon number in the range of 1 to 3 which are identical to or different from each other, n is an integer of 0 to 2, and m is an integer of 0 to 500.

This makes it possible to obtain absolutely excellent dispersion stability of the toner particles in the liquid developer while making the toner particles have the excellent charge characteristics.

In the method of the liquid developer according to the invention, it is also preferred that the grinding is performed by further using at least one selected from the group consisting of a quaternary cation silicone, an amino phenyl modified silicone and a phenyl modified silicone.

This makes it possible to obtain absolutely the excellent dispersion stability of the toner particles in the liquid developer while making the toner particles have absolutely excellent charge characteristics. Further, it is also possible to obtain the liquid developer having excellent development and transfer characteristics.

In the method of the liquid developer according to the invention, it is also preferred that an amount of the substance A contained in the finally obtained liquid developer is in the range of 0.1 mass % or more but 10.0 mass % or less.

This makes it possible to obtain absolutely the excellent dispersion stability of the toner particles in the liquid developer while making the toner particles have absolutely the excellent charge characteristics. Further, it is also possible to obtain the liquid developer having excellent development and transfer characteristics.

In the method of the liquid developer according to the invention, it is also preferred that an amount of the substance B contained in the finally obtained liquid developer is in the range of 0.1 mass % or more but 12.5 mass % or less.

This makes it possible to obtain absolutely the excellent dispersion stability of the toner particles in the liquid developer while making the toner particles have absolutely the excellent charge characteristics. Further, it is also possible to obtain the liquid developer having excellent development and transfer characteristics.

In a second aspect of the present invention, there is provided a liquid developer comprising:

an insulation liquid;

toner particles constituted of base particles including a resin material and a coloring agent and a substance A adhering to the base particles; and

a substance B;

wherein the resin material is at least one of a polyester resin and a styrene-acrylic resin, and wherein the substance A is an acrylic modified silicone sufficiently soluble to the insulation liquid and the substance B is at least one of a silanol group-containing polysiloxane and a fluorine modified silicone.

This makes it possible to provide the liquid developer having excellent positive charge characteristics.

### BRIEF DESCRIPTION OF THE DRAWINGS

FIG. 1 is a schematic view which shows one example of an image forming apparatus to which a liquid developer of the present invention can be used.

FIG. 2 is an enlarged view of a part of the image forming apparatus shown in FIG. 1.

### DESCRIPTION OF EXEMPLARY EMBODIMENTS

Hereinbelow, description will be made on preferred embodiments of the invention.

Method of Producing Liquid Developer

First, description will be made on a method of producing a liquid developer of the invention. In the invention, the liquid developer includes an insulation liquid and toner particles dispersed in the insulation liquid.

### First Embodiment

The method of producing the liquid developer of the present embodiment has the following five steps. The first step is to knead a toner material including a polyester resin and/or a styrene-acrylic resin as a resin material and a coloring agent to obtain a kneaded material (kneading step). The second step is to coarsely grind the kneaded material to obtain a coarsely ground kneaded material (coarsely ground material) (coarsely grinding step). Third step is to grind the obtained coarsely ground material under the presence of an acrylic modified silicone as a substance A, which is sufficiently soluble to the insulation liquid, in the insulation liquid to obtain a dispersion liquid in which fine particles are dispersed (wet grinding step). The fourth step is to subject the dispersion liquid to a heat treatment at a higher temperature than a glass transition temperature of the resin material (heating step). The fifth step is to mix the dispersion liquid having been subjected to the heat treatment with a silanol group-containing polysiloxane and/or a fluorine modified silicone as a substance B (mixing step).

Meanwhile, the resin material including the polyester resin and/or the styrene-acrylic resin used as a constituting material of the toner particles has negative charge characteristics in itself. Therefore, it is difficult to use the resin material for positively charged toner particles (liquid developer). Furthermore, even if the toner particles obtained by using such a resin material are positively charged by a charge controlling agent, it is difficult to obtain a sufficient charge amount. Further, it is difficult to grind such a resin material and obtain particles having a predetermined particle diameter.

In contrast, in the invention, it is possible to efficiently grind the toner material by grinding the toner material including the resin material and the coloring agent under the presence of the substance A in the insulation liquid as described above. In addition to that, it is possible to allow the acrylic modified silicone to adhere to surfaces of finally obtained toner particles by using the substance B in the mixing step and performing the heating step between the wet grinding step and the mixing step. Consequently, it is possible to easily produce the liquid developer having the excellent positive charge characteristics.

Hereinafter, description will be made on each step in detail.

Kneading Step

In the present step, the toner material including the polyester resin and/or the styrene-acrylic resin and the coloring agent is kneaded to obtain the kneaded material.

The kneading step is performed by using various kind of kneading machine such as a twin-screw kneading extruder, a kneader, a batch-type triaxial roll, a continuous biaxial roll, a wheel mixer, a blade-type mixer, and the like.

Resin Material

In the present step, is used the resin material containing the polyester resin and/or the styrene-acrylic resin.

The polyester resin and the styrene-acrylic resin have high transparency. In the case where they are used as a binder resin, it is possible to obtain high color development of obtained images. Therefore, they are used as the resin material reliably. In particular, the polyester resin has the high transparency. In the case where it is used as the binder resin, it is possible to obtain the high color development of the obtained images especially. On the other hand, the styrene-acrylic resin, generally, is obtained at extra low cost among various kind of resin materials used as the binder resin and can assist further reduction of a produce cost of the liquid developer. Therefore, in case of using such a resin material, it is possible to obtain the images having the high color development, thereby reliably using the polyester resin and the styrene-acrylic resin as the resin material.

In the invention, the styrene-acrylic resin means a resin obtained by a copolymerization between styrenes and acrylic compounds such as acrylonitrils and acrylic acid esters.

Examples of the styrenes include styrene, α-methyl styrene, t-butyl styrene, dimethyl styrene, acetoxy styrene, vinyl toluene and the like.

Examples of the acrylonitrils include acrylonitril, methacrylonitril and the like.

Examples of the acrylic acid esters include methyl (metha)acrylate, buthyl (metha)acrylate, nonyl (metha)acrylate, decyl (metha)acrylate, undecyl (metha)acrylate, dodecyl (metha)acrylate, tridecyl (metha)acrylate, tetradecyl (metha)acrylate, pentadecyl (metha)acrylate, hexadecyl (metha)acrylate, octadecyl (metha)acrylate, eicosyl (metha)acrylate, docosyl (metha)acrylate, hydroxyl polyoxy alkylene ether mono(metha)acrylate, and the like.

A polymerization ratio of each component constituting the styrene-acrylic resin is not limited particularly. Further, a molecular weight and a molecular weight distribution thereof are not also limited particularly.

An acid value of the resin material used in the invention is preferably in the range of 5 mgKOH/g or more but 20 mgKOH/g or less, and more preferably in the range of mgKOH/g or more but 15 mgKOH/g or less.

A glass transition temperature Tg of the resin material used in invention is preferably in the range of 15° C. or more but 70° C. or less, and more preferably in the range of 20° C. or more but 65° C. or less. In this specification, it is to be noted that the term “glass transition temperature Tg” means a temperature obtained as follows. A sample, namely the resin material, is subjected to a differential scanning calorimetry apparatus DSC-220C (manufactured by Seiko Instruments Inc.) under the conditions that a sample amount is 10 mg, a temperature raising speed is 10° C./min and a measurement temperature range is in the range of 10 to 150° C. to obtain a chart. Then, an extended line of a base line to the glass transition temperature in the obtained chart is crossed with a tangent which represents a maximal slop in a curve from a point at which a heat capacity of the sample suddenly changes in the chart to a vertex of a peak of the curve to obtain an intersection point of the tangent and the extended line. The glass transition temperature Tg is a temperature at the intersection point.

A softening point T1/2 of the resin material is not limited particularly, but preferably in the range of 50° C. or more but 130° C. or less, more preferably in the range of 50° C. or more but 120° C. or less, and even more preferably in the range of 60° C. or more but 115° C. or less. In this specification, the term “softening point” means a temperature at which softening is begun under the conditions that a temperature raising speed is 5° C./min and a diameter of a die hole is 1.0 mm in a high-floored flow tester (manufactured by Shimadzu Corporation).

The resin material constituting the toner particles of the liquid developer may contain any components other than the polyester resin and the styrene-acrylic resin as described above. However, an amount of the polyester resin and the styrene-acrylic resin contained in the resin material is preferably 50 mass % or larger, and more preferably 60 mass % or larger. This makes it possible to more conspicuously exhibit the effects of the invention.

Coloring Agent

As for a coloring agent, it is not particularly limited to a specific material, but known pigments, dyes or the like can be used.

In particular, the pigments are preferable among the materials described above as the resin material.

Other Components

Further, additional components other than the above components may be contained in the kneaded material. Examples of such other components include known wax, magnetic powder, and the like.

Further, the constituent material (component) of the kneaded material may further contain zinc stearate, zinc oxide, cerium oxide, silica, titanium oxide, iron oxide, a fatty acid, or a fatty acid metal salt, or the like in addition to the components described above.

Coarsely Grinding Step

Next, the kneaded material obtained in the above step is coarsely ground to obtain a coarsely ground material.

By using the coarsely ground material in which the kneaded material is coarsely ground as described above, it is possible to more efficiently obtain toner particles having a small particle diameter in the grinding step (fine grinding step) described later.

A method of coarsely grinding in the present step is not limited particularly, but is performed by using various kinds of grinding device such as a ball mill, a vibrational mill, a jet mill and a pin mill, a shredding device and the like.

An average particle diameter of the coarsely ground material obtained in the coarsely grinding step is preferably 1000 μm or less. The coarsely grinding step may be performed more than once.

Grinding Step (Fine Grinding Step)

Next, the coarsely ground material obtained in the above step is wet-ground in the insulation liquid (grinding step).

In the grinding step, the acrylic modified silicone as a substance A, which is sufficiently soluble to the insulation liquid, is contained in insulation liquid.

In the grinding step, the use of the substance A makes it possible to efficiently perform the grinding. This is because of the following reasons. The substance A existing in the insulation liquid in a stable manner adheres to surfaces of a ground material formed at the time of grinding. In other words, a part of silicone of the substance A has affinity with respect to the insulation liquid, so that an acrylic part of the substance A adheres to the ground material to form a coating. As described above, the substance A serves as a dispersant, so that the grinding of the ground material is performed efficiently. The effects as described above are exhibited conspicuously in the case of large crush strength.

As described above, by grinding the coarsely ground material under the presence of the substance A, it is possible to obtain the dispersion liquid in the present step. In the dispersion liquid, particles, in which the substance A adheres to surfaces of resin fine particles (toner base particles) including the resin material and the coloring agent, are dispersed in the insulation liquid.

A method of grinding in the present step is not limited particularly, but is performed by using various kinds of grinding (crushing) device such as a ball mill, a vibrational mill, a jet mill and a pin mill, shredding equipment and the like.

Insulation Liquid

The wet grind in the present step is performed in the insulation liquid.

The insulation liquid serves as a dispersion medium which disperses the toner particles in the finally obtained liquid developer.

Further, the insulation liquid has high insulation property to transfer the charged toner particles to a recording medium at the time of forming images.

Various insulation liquids can be used if they have sufficiently high insulation property. In more details, an electric resistance of such insulation liquid at room temperature (20° C.) is preferably equal to or higher than 1×10⁹ Ωcm, more preferably equal to or higher than 1×10¹¹ Ωcm, and even more preferably equal to or higher than 1×10¹³ Ωcm.

Further, a dielectric constant of the insulation liquid is preferably equal to or lower than 3.5.

Examples of the insulation liquids include: a dimethyl silicone oil such as KF-99, KF-96, KF-995 (produced by Shin-Etsu Cheical Co., Ltd.), AK35, AK50, AK100, AK350, AK1000 (produced by Wacker Chemie AG), SH200, SH510, and SH8400 (produced by Dow Corning Toray Co., Ltd.); a silicone oil having a larger polymerization degree than 20 such as a hydrogen modified silicone compound; a low molecular siloxane compound having a polymerization degree of 20 or less such as a cyclic siloxane compound including cyclopenta siloxane and decamethyl cyclic siloxane, and methyl tris(trimethyl siloxy)silane; an mineral oil such as ISOPAR E, ISOPAR G, ISOPAR H, ISOPAR L (“ISOPAR” is a product name of Exxon Mobil Corporation); SHELLSOL 70, SHELLSOL 71 (“SHELLSOL” is a product name of Shell Oil), Amsco OMS, Amsco 460 solvent (“Amsco” is a product name of Spirit Co., Ltd.), a low-viscosity or high-viscosity liquid paraffin (produced by Wako Pure Chemical Industries, Ltd.), and the like; a fatty acid ester such as a fatty acid glyceride, a fatty acid monoester, a medium fatty acid ester, and the like, or a vegetable oil which contains them; octane, isooctane, decane, isodecane, decaline, nonane, dodecane, isodecane, cyclohexane, cyclooctane, cyclodecane, benzene, toluene, xylene, mesitylene, buthyl acetate, isopropanol and the like. These insulation liquids may be used singly or in combination of two or more of them.

In the present step, the dimethyl silocone oil is preferable as the insulation liquid among compounds described above. This ensures that the excellent dispersion stability of the toner particles in the liquid developer is obtained while obtaining excellent productivity of the liquid developer.

Substance A

In the present step, the acrylic modified silicone which is sufficiently soluble to the insulation liquid is used as the substance A. This makes it possible to reliably allow the substance A to adhere to the vicinity of the surface of each of the base particles which are constituted of the material containing the resin material and the coloring agent. Such a substance A has a silicone part which is an affinity group with respect to the insulation liquid and an acrylic part which is an affinity group with respect to the base particles. Therefore, it is possible to obtain the excellent dispersion stability of the toner particles in the liquid developer. Further, in the later steps, it is possible to reliably allow a silanol group-containing polysiloxane as the substance B to adhere to the toner particles, thereby obtaining the excellent positive charge characteristics of the toner particles. Further, it is possible to obtain the excellent dispersion stability of the toner particles in the finally obtained liquid developer and an excellent storage stability of the liquid developer. In addition, the substance A has also a function of preventing the toner particles from aggregating at the time of producing the liquid developer.

In this regard, it is to be noted that the term “sufficiently soluble” is defined by the following processes.

First, the acrylic modified silicone (solid state or liquid state) is added to a carrier (insulation liquid) at an amount of 5 wt % thereof to obtain a mixture. Then, the mixture is subjected to an ultrasonic washing machine ASU-2M (produced by AS ONE Corporation) for 15 minutes under the measurement conditions that a temperature is 25° C., power is W, and frequency is 42 kHz to perform an ultrasonic dispersion of the acrylic modified silicone. Thereafter, the mixture is left for 24 hours at the temperature of 25° C. Then, uneven dispersion or white turbidity in the mixture is observed in a visible contact when a light is transmissive through the mixture (sample). A state of the sample having no uneven dispersion or no white turbidity is defined as the term “sufficiently soluble” when the light is transmissive through the sample. On the other hand, a state of the sample having the uneven dispersion or the white turbidity is defined as the term “sufficiently insoluble (insufficiently soluble)” when the light is transmissive through the sample.

Further, a solubility of the acrylic modified silicone with respect to the insulation liquid of 100 g at 25° C. is preferably 5 g or more, and more preferably 10 g or more.

Further, it is preferred that the substance A is the acrylic modified silicone in which radical polymerization monomers are copolymerized.

This makes it possible to obtain absolutely the excellent dispersion stability of the toner particles in the liquid developer while making the toner particles have sufficiently excellent charge characteristics. Further, it is possible to obtain the liquid developer having the excellent development and transfer characteristics.

In the case where the substance A is the acrylic modified silicone in which the radical polymerization monomers are copolymerized, it is preferred that the radical polymerization monomers have polar groups.

This makes it possible to obtain absolutely the excellent positive charge characteristics of the toner particles. Further, it is possible to obtain the excellent dispersion stability of the toner particles in the finally obtained liquid developer and an excellent storage stability of the liquid developer.

Examples of the polar groups of the radical polymerization monomers include a hydroxyl group, an amino group, an amido group, a sulfo group and the like. Among them, the radical polymerization monomers including the amino group are preferable. This makes it possible to obtain absolutely the excellent dispersion stability of the toner particles in the liquid developer while making the toner particles have absolutely the excellent charge characteristics.

Examples of the radical polymerization monomer include a hydrophilic or hydrophobic radical polymerization monomer and the like. Specifically, examples of the hydrophilic or hydrophobic radical polymerization monomer include: acryl acids such as acrylic acid or methacrylic acid (hereinafter referred to as “(metha)acrylic acid”); alkyl esters such as methyl (metha)acrylate, butyl (metha)acrylate, 2-ethylhexyl (metha)acrylate, hydroxyethyl (metha)acrylate, hydroxypropyl (metha)acrylate, and hydroxybutyl (metha)acrylate; acid amides such as acrylic amide; amine derivatives such as dimethyl aminoethyl (metha)acrylate, and diethyl aminoethyl (metha)acrylate; an acid neutralizing material of the acid amides or the amine derivatives; aminoacetic acid betaine derivatives of a reactant of the amine derivatives and monochloro sodium acetate; sulfo betaine type derivatives of a sulfonate of the amine derivatives; quaternary cation type derivatives of the amine derivatives; phosphate group derivatives such as 2-acryloyloxyethyl phosphoric acid; sulfonic group derivatives such as 2-acrylamide-2-methylpropane sulfonic acid; various kind of (metha)acrylate derivatives such as perfluoro decylethyl (metha)acrylate, perfluoro octylethyl (metha)acrylate, perfluoro hexylethyl (metha)acrylate, perfluoro butylethyl (metha)acrylate, perfluoro esters; epoxy group-containing (metha)acrylates such as glycidyl (metha)acrylate, and 3,4-epoxy cyclohexyl methyl (metha) acrylate.

Further, examples compounds other than the acrylate and/or methacrylate in the radical polymerization monomers in the invention include styrene or styrene derivatives, fumaric acid, itaconic acid, maleic acid, crotonic acid or derivatives containing neutrizing salts of these acids and sodium hydroxide, potassium hydroxide or ammonia, a radical polymerization silicone compound such as vinyltrimethoxysilane and γ-methacryloxy propyl trimethoxysilane; a radical polymerization macromonomer such as polystyrene and polycaprolactone having at least one of radical polymerization groups in a molecule thereof, which includes acrylonitrile, vinyl pyrrolidone, vinyl acetate, and vinyl alkyl ether; and the like.

The radical polymerization monomers as described above may be used singly or in combination of two or more of them. Further, among the radical polymerization monomers, it is preferred that at least one of the alkyl esters and the amine derivatives is used. This makes it possible obtain further the excellent dispersion stability of the toner particles in the liquid developer.

It is preferred that the substance A is the acrylic modified silicone in which silicone macromeres represented by the following general formula (1) are copolymerized.

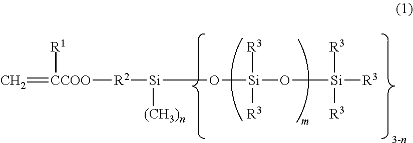

where R¹ is a hydrogen atom or a methyl group, R² is a bivalent hydrocarbon group having a carbon number in the range of 1 to 5, R³ is a hydrocarbon group having the carbon number in the range of 1 to 3, an aryl group or a fluorine-substituted hydrocarbon having the carbon number in the range of 1 to 3 which are identical to or different from each other, n is an integer of 0 to 2, and m is an integer of 0 to 500.

If the substance A is the acrylic modified silicone in which the silicone macromeres represented by the above general formula (1) are copolymerized, it is possible to obtain absolutely the excellent dispersion stability of the toner particles in the liquid developer while making the toner particles have absolutely the excellent charge characteristics. Further, it is possible to obtain the liquid developer having the excellent development and transfer characteristics.

Examples of such silicone macromeres include a one end reactivity organopolysiloxane having an acrylic group or a methacrylic group at the one end, and the like. Among them, is preferable a one end methacrylic modified dimethyl polysiloxane represented by the following general formula (2) or (3). This makes it possible to conspicuously exhibit the effects as described above.

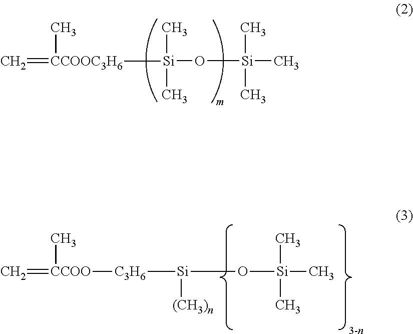

where m is an integer of 1 to 500 and n is an integer of 0 to 2.

In particular, if the substance A is the acrylic modified silicone in which the radical polymerization monomers and the silicone macromeres are copolymerized as described above, it is possible to obtain the excellent dispersion stability of the toner particles in the liquid developer.

Further, in the case where the substance A has the polar groups such as the amino groups, it is possible to obtain absolutely excellent charge characteristics. This means that the substance A has a function-separation type structure having the polar groups such as the amino groups with the silicone part of the affinity group with respect to the insulation liquid and the acrylic part of the affinity group with respect to the base particles. As a result, the substance A has the excellent dispersion stability and the excellent charge characteristics.

Further, in the case where the substance A has the polar group such as the amino groups, it is possible to allow the substance A to reliably adhere to the vicinity of the surface of each base particle. Moreover, in the later steps, it is possible to reliably allow the substance B to adhere to the toner particles, thereby obtaining the excellent positive charge characteristics of the toner particles. Further, it is possible to obtain the excellent dispersion stability of the toner particles in the finally obtained liquid developer and the excellent storage stability of the liquid developer. In addition, it is possible to make the particles have excellent charge property.

In contrast, in the case of an amino modified silicone which is soluble to the insulation liquid and has no acrylic part as the substance A, a part of the amino group adheres to the particles as an affinity group with respect to the particles instead of the acrylic part as the substance A. In such an amino modified silicone, a silicone part is used as an affinity group with respect to the insulation liquid and the part of the amino group is used as the affinity group with respect to the particles. Therefore, the amino modified silicone soluble to the insulation liquid serves as a dispersant, but makes it impossible to efficiently improve the charge property as the substance A having the amino group as described above. Further, in order to improve the dispersion stability, even if the amino groups of the polar groups are introduced into the amino modified silicone, the amino groups cause cross-links among the particles, thereby lowering the dispersibility conspicuously.

Further, when an amount of the silicone macromeres as the substance A in the acrylic modified silicone is defined as X1 [parts by weight] and an amount of the radical polymerization monomers is defined as X2 [parts by weight], a ratio X1/X2 between the amount of the silicone macromeres and the amount of radical polymerization monomers is preferably in the range of 0.3 or more but 4.0 or less, and more preferably in the range of 0.5 or more but 2.5 or less. This makes it possible to improve the solubility of the substance A with respect to the insulation liquid, so that it is possible to further improve the dispersion stability of the toner particles in the liquid developer.

In the present step, with regard to an amount of the substance A, a ratio of the substance A in the finally obtained liquid developer is preferably in the range of 0.1 mass % or more but 10.0 mass % or less, more preferably in the range of 0.1 mass % or more but 7.0 mass % or less, and even more preferably in the range of 0.1 mass % or more but 5.0 mass % or less.

This makes it possible to obtain excellent dispersion stability of the toner particles in the liquid developer while making the toner particles have the excellent charge characteristics. Further, it is possible to obtain the liquid developer having the excellent development and transfer characteristics.

Quaternary Cation Silicone, Amino Phenyl Modified Silicone and Phenyl Modified Silicone

In the following description, a quaternary cation silicone, an amino phenyl modified silicone and a phenyl modified silicone are defined as a substance C collectively. Further, in the following steps, description will be made on a case including the substance C centrically.

In the present step, it is preferred that at least one of the substances C is used further. In particular, it is preferred that the substance C in addition to the substance A described above are used. This makes it possible to allow the substance A and the substance C to adhere to the vicinity of the surface of each base particle. Moreover, in the later steps, it is possible to reliably allow the substance B to adhere to the toner particles, thereby obtaining the excellent positive charge characteristics of the toner particles. Further, it is possible to obtain the excellent dispersion stability of the toner particles in the finally obtained liquid developer and the excellent storage stability of the liquid developer.

The quaternary cation silicone means a silicone having a quaternary ammonium group. The expression “silicone having the quaternary ammonium group” means an arbitrary silicone having one or more quaternary ammonium groups. These quaternary ammonium groups can bond at an alpha position or an omega position of the silicone as a side group (branch group). They may be directly bonded to a chain of polysiloxane or carried (held) on a hydrocarbon base chain.

In the invention, the term “silicone” has a structure in which silicon atoms and oxygen atoms are alternately bonded with each other as a known bond, namely a siloxane bond (—Si—O—Si—), as known generally, and means an arbitrary polymer characterized by existence of silicon-oxygen bonds. These silicones or polysiloxanes, generally, are obtained by polycondensation of appropriately functioned silanes. A hydrocarbon base group held by silicon atoms most commonly is a lower alkyl group, in particular a methyl group, a fluoro alkyl group and an aryl group, in particular a phenyl group. Such silicones are made a sale under the names of AbilQuat 3272, Abil B9905, AbilQuat 3474 and Abil K3270 from Goldschmidt, Silquat Q-100, Silquat Q-200WS, Silquat AX, Silquat AC, Silquat AD and Silquat AM from LipoFrance (produced by Siltech in all), Magnasoft Exhaust and Silsoft C-880 from OSI and Pecosil 14-PQ and Pecosil 36-PQ from UCIB (produced by PhoenixChemical Inc.).

These silicones are disclosed in EP B-530974, DE B-3719086, DE B-3705121, EP B-617607 and EP B-714654 particularly. Among them, SilsenseQ-Plus (produced by The Lubrizol Corporation) is particularly preferable. By using the SilsenseQ-Plus (produced by The Lubrizol Corporation) as the substance C, it is possible to obtain the excellent dispersion stability of the toner particles in the finally obtained liquid developer and the excellent storage stability of the liquid developer while obtaining the excellent positive charge characteristics of the toner particles.

Examples of the amino phenyl modified silicone as the substance C include amino propyl phenyl trimethicone and the like. By using the amino propyl phenyl trimethicone as the substance C, it is possible to obtain the excellent dispersion stability of the toner particles in the finally obtained liquid developer and the excellent storage stability of the liquid developer while obtaining the excellent positive charge characteristics of the toner particles.

Examples of the amino phenyl modified silicone used as the substance C include 2-2078 Fluid (produced by Dow Corning Toray Co., Ltd.) and the like.

Examples of the phenyl modified silicone as the substance C include a phenyl siloxy silicate resin, trimethyl pentaphenyl trisiloxane and the like. By using the phenyl siloxy silicate resin and the trimethyl pentaphenyl trisiloxane as the substance C, it is possible to obtain the excellent dispersion stability of the toner particles in the finally obtained liquid developer and the excellent storage stability of the liquid developer while obtaining the excellent positive charge characteristics of the toner particles.

Examples of the phenyl modified silicone used as the substance C include SH556 (produced by Dow Corning Toray Co., Ltd.), PH1555 (produced by Dow Corning Toray Co., Ltd.), silshine-151 (produced by Momentive) and the like.

As described above, at least one selected from the group consisting of the quaternary cation silicone, the amino phenyl modified silicone and the phenyl modified silicone is used as the substance C. However, the quaternary cation silicone and/or the amino phenyl modified silicone are preferable, and the amino phenyl modified silicone is more preferable. This makes it possible to obtain the excellent dispersion stability of the toner particles in the finally obtained liquid developer and the excellent storage stability of the liquid developer while obtaining the excellent positive charge characteristics of the toner particles.

In the present step, with regard to an amount of the substance C, a ratio of the substance C in the finally obtained liquid developer is preferably in the range of 0.02 mass % or more but 4.0 mass % or less, and more preferably in the range of 0.05 mass % or more but 1.0 mass % or less. This makes it possible to obtain the excellent dispersion stability of the toner particles in the liquid developer while making the toner particles have the excellent charge characteristics. Further, it is possible to obtain the liquid developer having the excellent development and transfer characteristics.

L₁ (μm) represents the circumference of a projected image of a toner particle that is a subject of measurement, and L₀ (μm) represents the circumference of a perfect circle (a geometrically perfect circle) having the same area as that of the projected image of the toner particle that is a subject of measurement. In this case, the present step is preferably performed so that an average roundness R⁰ of the toner particles contained in the dispersion liquid (dispersion liquid before a heat treatment described later) obtained in the present step satisfies a relation of 0.800≦R₀≦0.889. This makes it possible to obtain the excellent storage stability and transcription efficiency of the liquid developer while obtaining excellent uniformity of the charge characteristics among the toner particles.

Heating Step

Thereafter, the dispersion liquid obtained through the wet grinding step is subjected to the heat treatment. In particular, the dispersion liquid is subjected to the heat treatment at a high temperature than the glass transition temperature of the resin material.

This makes it possible to reliably adjust the roundness of the toner particles while allowing the substance A to adhere to the vicinity of the surface of each particle. As a result, it is possible to obtain the excellent dispersion stability of the toner particles in the liquid developer while obtaining the excellent positive charge characteristics of the toner particles constituting the finally obtained liquid developer. In addition, it is also possible to obtain excellent transcription efficiency and development efficiency of the toner particles.

When the glass transition temperature of the resin material is defined as Tg [° C.], the treatment temperature in the present step is preferably in the range of Tg [° C.] or more but Tg+30 [° C.] or less, more preferably in the range of Tg [° C.] or more but Tg+20 [° C.] or less, and even more preferably in the range of Tg+5 [° C.] or more but Tg+10 [° C.] or less. This makes it possible to obtain the excellent productivity of the liquid developer while exhibiting the effects as described above more conspicuously. In this regard, in the case where the resin material constituting the coarsely ground compound is constituted of various kinds of components (resin components), a glass transition temperature as a whole of the coarsely ground compound is used as the Tg.

A time of the heating treatment in the present step is preferably in the range of 5 minutes or more but 150 minutes or less, and more preferably in the range of 10 minutes or more but 90 minutes or less. This makes it possible to obtain the excellent productivity of the liquid developer while exhibiting the effects as described above more conspicuously.

Further, the present step is performed by heating while adding shear force to the dispersion liquid. This makes it possible to obtain the excellent storage stability and transcription efficiency of the liquid developer while making the toner particles have the excellent charge characteristics.

In the case where the present step is performed while adding the shear force, the shear force is preferably in the range of 300 rpm or more but 1200 rpm or less, and more preferably in the range of 400 rpm or more but 900 rpm or less.

Furthermore, L₁ (μm) represents the circumference of a projected image of a toner particle that is a subject of measurement, and L₀ (μm) represents the circumference of a perfect circle (a geometrically perfect circle) having the same area as that of the projected image of the toner particle that is a subject of measurement. In this case, when an average roundness of the toner particles contained in the dispersion liquid before the present step (before the heating treatment) is defined as R₀, and an average roundness of the toner particles contained in the dispersion liquid after the present step (after the heating treatment) is defined as R₁, the present step is preferably performed so that the R₁ is 0.890 or more and the R₁ and R₀ satisfy a relation of 0.01≦R₁−R₀≦0.10. This makes it possible to obtain the excellent storage stability and transcription efficiency of the liquid developer while obtaining the excellent uniformity of the charge characteristics among the toner particles.

As described above, R₁ may be 0.890 or more, but is preferably in the range of 0.895 or more but 0.97 or less, and more preferably in the range of 0.900 or more but 0.960 or less. This makes it possible to exhibit the effects as describe above more conspicuously.

Further, the R₁ and R₀ preferably satisfy the relation of 0.01≦R₁−R₀≦0.10, more preferably a relation of 0.02≦R₁−R₀≦0.09, and even more preferably a relation of 0.03≦R₁−R₀≦0.08. This makes it possible to exhibit the effects as describe above more conspicuously.

The roundness of the particle, for example, is measured by using flow particle image analyzers FPIA-3000 and FPIA-3000S (produced by Sysmex Corporation) and the like. In the analyzers, is used a system that particles dispersing in a dispersion medium are measured by a flow image processing method. A particle suspension liquid sucked is introduced to a flat seath flow cell to form an oblate sample fluid by a seath liquid. Then, a stroboscopic light is radiated to the sample fluid, to thereby take an image of the particle by using a CCD camera. By using the circumference obtained from the image of the particle subjected to a 2D image treatment, the roundness is calculated.

Mixing Step

Thereafter, the dispersion liquid having been subjected to the heating treatment is mixed with a silanol group-containing polysiloxane and/or a fluorine modified silicone as the substance B.

Substance B

In the present step, the silanol group-containing polysiloxane and/or the fluorine modified silicone is used as the substance B. This ensures that the substance B reliably adheres to the vicinity of the surface of each particle to which the substance A has adhered, so that it is possible to obtain sufficiently excellent positive charge characteristics of the toner particles. Further, it is possible to lower viscous property of the whole of the liquid developer while obtaining the excellent dispersion stability of the toner particles in the liquid developer and the excellent storage stability of the liquid developer.

Further, the use of the silanol group-containing polysiloxane as the substance B makes it possible to make the particles have especially excellent charge property. Furthermore, the use of the fluorine modified silicone makes it possible to obtain the excellent storage stability and transcription efficiency of the liquid developer while obtaining the excellent uniformity of the charge characteristics among the toner particles.

The silanol group-containing polysiloxane having an M unit (R¹R²R³SiO_{1/2}) and a Q unit (SiO_{4/2}) and the fluorine modified silicone are reliably used as the substance B, where each of R¹, R² and R³ is independently a monovalent aliphatic hydrocarbon group having a carbon number of 1 or more but 10 or less or a monovalent aromatic hydrocarbon group having a carbon number of 6 or more but 15 or less. This makes it possible to obtain the excellent dispersion stability of the toner particles in the liquid developer while making the toner particles have the excellent charge characteristics. Further, it is possible to obtain the liquid developer having the excellent development and transfer characteristics.

Examples of the silanol group-containing polysiloxane as the substance B include tetra (trimethylsiloxy) silane and the like. The use of tetra (trimethylsiloxy) silane as the substance B makes it possible to obtain absolutely the excellent positive charge characteristics of the toner particles. Further, it is possible to obtain the excellent dispersion stability of the toner particles in the liquid developer and the excellent storage stability of the liquid developer.

Examples of the silanol group-containing polysiloxane used as the substance B include SS4267 (produced by Momentive), DC593 (produced by Dow Corning Toray Co., Ltd.), SS4230 (produced by Momentive) and the like.

Examples of the fluorine modified silicone as the substance B include fluorinated alkyl dimethyl trimethyl siloxy silicic acid and the like. By using the fluorinated alkyl dimethyl trimethyl siloxy silicic acid as the substance B, it is possible to obtain the excellent dispersion stability of the toner particles in the liquid developer and the excellent storage stability of the liquid developer.

Examples of the fluorine modified silicone used as the substance B include XS66-B8226 (produced by Momentive), XS66-C1191 (produced by Momentive), XS66-B8636 (produced by Momentive) and the like.

In the present step, with regard to an amount of the substance B, an ratio of the substance B in the finally obtained liquid developer is preferably in the range of 0.1 mass % or more but 10.0 mass % or less, more preferably in the range of 0.1 mass % or more but 7.0 mass % or less, and even more preferably in the range of 0.1 mass % or more but 2.0 mass % or less. This makes it possible to obtain the excellent dispersion stability of the toner particles in the liquid developer while making the toner particles have the excellent charge characteristics. Further, it is possible to obtain the liquid developer having the excellent development and transfer characteristics.

### Second Embodiment

Next, description will be made on a second embodiment of a method of producing a liquid developer of the invention. In the following description, an explanation will be made by focusing on different points from the first embodiment and an explanation on the common points is omitted.

The method of producing the liquid developer of the present embodiment has the following two steps. The first step is to grind particles constituted of a material including the resin material and the coloring agent under the presence of the substances A and B in the insulation liquid to obtain a dispersion liquid (wet grinding step). The second step is to subject the dispersion liquid to a heat treatment at a higher temperature than the glass transition temperature of the resin material (heating step) while giving shear force to the dispersion liquid. In other words, the method is the same as that of the first embodiment described above, except that the wet grinding step is performed under the presence of the substance B in addition to the substance A and the mixing step after the heating step is omitted. Even case of such a method can exhibit the same effects as described above. The omission of the mixing step makes it possible to obtain absolutely the excellent productivity of the liquid developer.

Liquid Developer

The liquid developer of the invention contains an insulation liquid and toner particles in which the substance A adheres to base particles including the resin material and the coloring agent. Further, the liquid developer of the invention contains the substance B further. This makes it possible to provide the liquid developer having the excellent positive charge characteristics.

Furthermore, the substance B may adhere to the vicinity of the surface of each toner particle, and a part thereof may exist in the liquid developer with the release of the vicinity of the surface. This makes it possible to obtain further excellent charge characteristics of the whole of the liquid developer.

The liquid developer of the invention, for example, can be produced by using the method as described above.

An amount of the toner particles in the liquid developer is preferably in the range of 10 mass % or more but mass % or less, and more preferably in the range of 20 mass % or more but 50 mass % or less.

Furthermore, an average particle diameter in volume (D₅₀) of the toner particles constituting the liquid developer is preferably in the range of 2 μm or more but 4 μm or less.

In the present specification, the average particle diameter in volume (D₅₀) means a 50% average particle diameter (D₅₀) of the particles converted to a spherical shape by a light scattering method and is a value obtained as follows. Particles in a dispersion medium are exposed to a light to measure generated differential scattering lights with detectors placed at sides of the dispersion medium and to obtain measured values. Assuming that the particles formed into inherently indefinite shape are formed into a spherical shape, a cumulative distribution curve of the particles is obtained by using the measured values as that a total volume of total particles converted to spheres having the same volume as that of the particles is defined as 100%. At that time, a point of 50% of the relative amount of the particles in the cumulative distribution curve is defined as the average particle diameter in volume (D₅₀). Examples of a measurement apparatus include a laser diffraction and scattering particle size analyzer (“Microtrack MT-300” produced by NIKKISO CO., LTD.) and the like. In this regard, it is to be noted that each average particle diameter in volume (D₅₀) in the Examples described later is a value obtained by using the Microtrack MT-300.

Furthermore, the liquid developer may contain any component other than the above components. Examples of such a component include a know wax, magnetic particles, zinc stearate, zinc oxide, cerium oxide, silica, titanium oxide, ferric oxide, a fatty acid, a metal salt of the fatty acid, a dispersant, an external additive, a known antioxidant, a charge control agent and the like. These components may be used in any step of the method described above. In other words, these components may be included in the particles used in the wet grinding step, and added at the time of the wet grinding step, the heating step or mixing step.

Image Forming Apparatus

Next, description will be made with regard to a preferred embodiment of an image forming apparatus to which the liquid developer of the invention can be used.

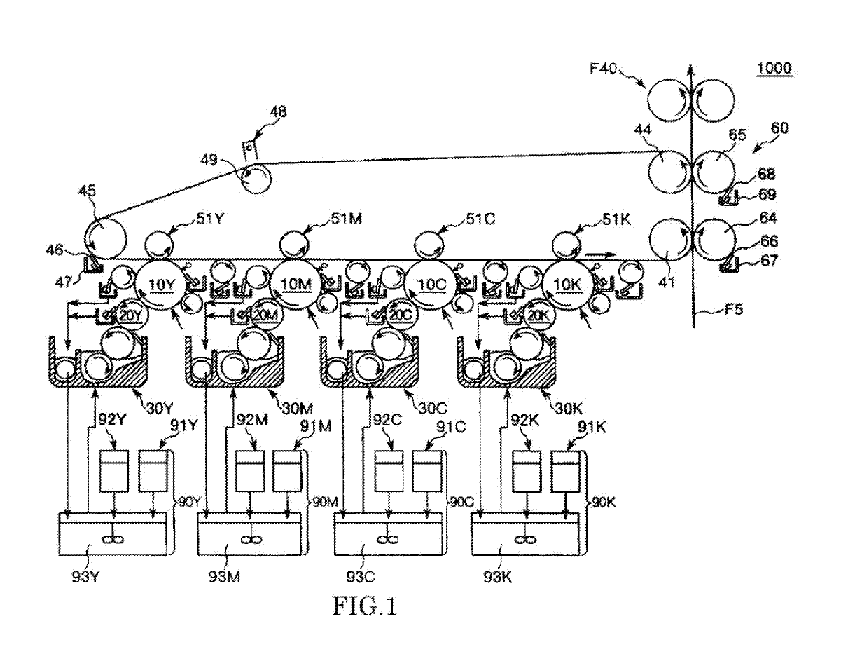

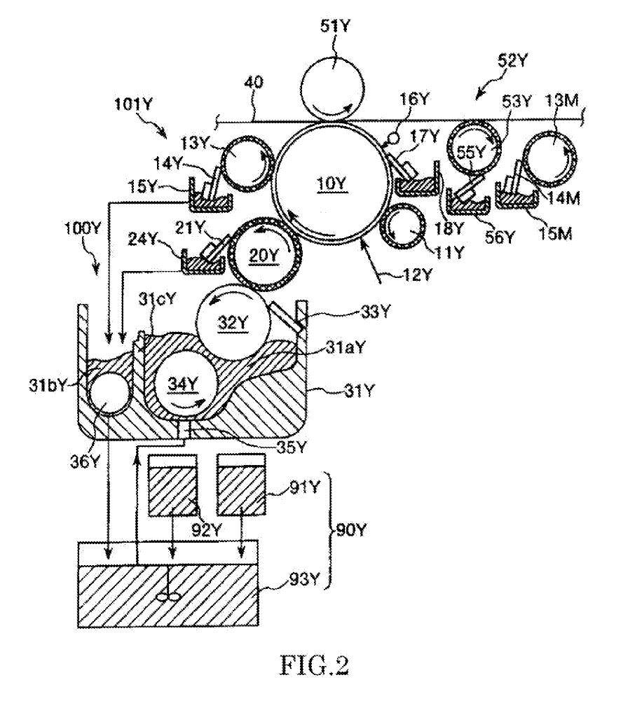

FIG. 1 is a schematic view which shows a preferred embodiment of an image forming apparatus to which the liquid developer of the invention can be used. FIG. 2 is an enlarged view of a part of the image forming apparatus shown in FIG. 1.

As shown in FIG. 1 and FIG. 2, the image forming apparatus 1000 includes four developing sections comprised of 30Y, 30M, 30C and 30K, a transfer section (an intermediate transfer section 40 and a secondary transfer unit (secondary transfer section) 60), a fixing section (fixing unit) F40 and four liquid developer supply sections 90Y, 90M, 90C and 90K.

The developing sections 30Y, 30M and 30C include respectively a yellow (Y) liquid developer, a magenta (M) liquid developer, and a cyan (C) liquid developer, and have functions of developing latent images with the liquid developers to form monochromatic color images corresponding to the respective colors. Further, the developing section 30K includes a black (K) liquid developer, and has a function of developing a latent image with the liquid developer to form a black monochromatic image.

The developing sections 30Y, 30M, 30C and 30K have the same structure. Therefore, in the following, the developing section 30Y will be representatively described.

As shown in FIG. 2, the developing section 30Y includes a photoreceptor 10Y which carries a latent image and rotates in the direction of the arrow shown in the drawings. The developing section 30Y further includes an electrifying roller 11Y, an exposure unit 12Y, a developing unit 100Y, a photoreceptor squeeze device 101Y, a primary transfer backup roller 51Y, an electricity removal unit 16Y, a photoreceptor cleaning blade 17Y, and a developer collecting section 18Y.

The photoreceptor 10Y includes a cylindrical conductive base member and a photosensitive layer which is constituted of a material such as amorphous silicon or the like formed on the outer peripheral surface of the base member, and is rotatable about the axis thereof in the clockwise direction as shown by the arrow in FIG. 2 in the present embodiment.

The liquid developer is supplied onto the surface of the photoreceptor 10Y from the developing unit 100Y so that a layer of the liquid developer is formed on the surface thereof.

The electrifying roller 11Y is a device for uniformly electrifying the surface of the photoreceptor 10Y. The exposure unit 12Y is a device that forms an electrostatic latent image on the photoreceptor 10Y charged by means of laser beam irradiation. The exposure unit 12Y includes a semiconductor laser, a polygon mirror, an F-θ lens, or the like, and irradiates a modulated laser beam onto the electrified photoreceptor 10Y in accordance with image signals received from a host computer such as a personal computer, a word processor or the like not shown in the drawings.

The developing unit 100Y is a device which develops the latent image formed on the photoreceptor 10Y with the liquid developer of the invention. The details of the developing unit 100Y will be described later.

The photoreceptor squeeze device 101Y is disposed so as to face the photoreceptor 10Y at the downstream side of the developing unit 100Y in the rotational direction thereof. The photoreceptor squeeze device 101Y is composed from a photoreceptor squeeze roller 13Y, a cleaning blade 14Y which is press contact with the photoreceptor squeeze roller 13Y for removing a liquid developer adhering to the surface of the photoreceptor squeeze roller 13Y, and a developer collecting section 15Y for collecting the removed liquid developer. The photoreceptor squeeze device 101Y has a function of collecting an excess carrier (insulation liquid) and a fog toner which is inherently unnecessary from the liquid developer developed by the photoreceptor 10Y, thereby increasing a ratio of the toner particles in the image to be formed.

The primary transfer backup roller 51Y is a device for transferring a monochrome toner image formed on the photoreceptor 10Y to the intermediate transfer section (belt) 40 described later.

The electricity removal unit 16Y is a device for removing a remnant charge on the photoreceptor 10Y after an intermediate image has been transferred to the intermediate transfer section 40 by the primary transfer backup roller 51Y.

The photoreceptor cleaning blade 17Y is a member made of rubber and provided in contact with the surface of the photoreceptor 10Y, and has a function of scrapping off the liquid developer remaining on the photoreceptor 10Y after the image has been transferred onto the intermediate transfer section 40 by the primary transfer backup roller 51Y.

The developer collecting section 18Y has a function of collecting the liquid developer removed by the photoreceptor cleaning blade 17Y.

The intermediate transfer section 40 is composed from an endless elastic belt which is wound around a belt drive roller 41 to which driving force is transmitted by a motor not shown in the drawings, a pair of driven rollers 44 and 45. The intermediate transfer section 40 is rotationally driven in the anticlockwise direction by the belt drive roller 41 while being in contact with the photoreceptors 10Y, 10M, 10C and 10K at each of positions that the primary transfer backup rollers 51Y, 51M, 51C and 51K are in contact with an intermediate transfer belt (feed belt).

The intermediate transfer section 40 is constructed so that a predetermined tension is given by the tension roller 49 to prevent loosening of the endless elastic belt. The tension roller 49 is disposed at the downstream side of the intermediate transfer section 40 in the moving direction thereof with respect to one driven roller 44 and at the upstream side of the intermediate transfer section 40 in the moving direction thereof with respect to the other driven roller 45.

Monochromatic images corresponding to the respective colors formed by the developing sections 30Y, 30M, 30C and 30K are sequentially transferred by the primary transfer backup rollers 51Y, 51M, 51C and 51K so that the monochromatic images corresponding to the respective colors are overlaid on the intermediate transfer section 40, thereby enabling a full color toner image (intermediate transferred image) to be formed on the intermediate transfer section 40 which will be described later.

The intermediate transfer section 40 carries the monochromatic images formed on the respective photoreceptors 10Y, 10M, 10C and 10K in a state that these images are successively secondary-transferred onto the belt so as to be overlaid one after another, and the overlaid images are transferred onto a recoding medium F5 such as paper, film and cloth as a single color image in the secondary transfer unit 60 described later. Therefore, when the toner image is transferred onto the recording medium F5 in the secondary transfer process, there is a case that the recording medium F5 is not a flat sheet material due to fibers thereof. The elastic belt is employed as a means for increasing a secondary transfer characteristic for such a non-flat sheet material.

Further, the intermediate transfer section 40 is also provided with a cleaning device which is composed form an intermediate transfer section cleaning blade 46, a developer collecting section 47 and a non-contact type bias applying member 48.

The intermediate transfer section cleaning blade 46 and the developer collecting section 47 are arranged on the side of the driven roller 45.

The intermediate transfer section cleaning blade 46 has a function of scrapping off of the liquid developer adhering to the intermediate transfer section 40 to remove it after the toner image has been transferred onto the recording medium F5 by the secondary transfer unit (secondary transfer section) 60.

The developer collecting section 47 has a function collecting the liquid developer removed by the intermediate transfer section cleaning blade 46.

The non-contact type bias applying member 48 is disposed so as to be apart from the intermediate transfer section 40 at an opposite position of the tension roller 49 through the intermediate transfer section (that is, elastic belt) 40. The non-contact type bias applying member 48 applies a bias voltage having a reversed polarity with respect to a polarity of the toner particles to each of the toner particles (solid content) contained in the liquid developer remaining on the intermediate transfer section 40 after the image has been secondary-transferred onto the recording medium 5F. This makes it possible to remove electricity from the remaining toner particles so that it is possible to lower electrostatic adhesion force of the toner particles to the intermediate transfer section 40. In this embodiment, a corona electrification device is used as the non-contact type bias applying member 48.

In this regard, it is to be noted that the non-contact type bias applying member 48 may not be necessarily disposed at the opposite position of the tension roller 49 through the intermediate transfer section (that is, elastic belt) 40. For example, the non-contact type bias applying member 48 may be disposed at any position between the downstream side of the intermediate transfer section 40 in the moving direction thereof with respect to one driven roller 44 and the upstream side of the intermediate transfer section 40 in the moving direction thereof with respect to the other driven roller 45 such as any position between the driven roller 44 and the tension roller 49. Note that as the non-contact type bias applying member 48, various known non-contact type electrification devices other than the corona electrification device may be employed.

An intermediate transfer second squeeze device 52Y is provided at the downstream side of the primary transfer backup roller 51Y in the moving direction of the intermediate transfer section 40.

The intermediate transfer squeeze device 52Y is provided as a means for removing an excess amount of the insulation liquid from the transferred liquid developer in the case where the liquid developer transferred onto the intermediate transfer section 40 does not have a desired dispersion state.

The intermediate transfer squeeze device 52Y includes an intermediate transfer squeeze roller 53Y, an intermediate transfer squeeze roller cleaning blade 55Y which is in press contact with the intermediate transfer squeeze roller 53Y for cleaning the surface thereof, and a liquid developer collecting section 56Y which collects the liquid developer removed from the intermediate transfer squeeze roller 53Y by the intermediate transfer squeeze roller cleaning blade 55Y.

The intermediate transfer squeeze device 52Y has a function of collecting an excess carrier (insulation liquid) from the liquid developer primary-transferred to the intermediate transfer section 40 to increase a ratio of the toner particles in an image to be formed and collecting a fog toner which is inherently unnecessary.

The secondary transfer unit 60 is provided with a pair of secondary transfer rollers which are arranged so as to depart from each other for a predetermined distance along the moving direction of the recording medium F5. Among the pair of the secondary transfer rollers, the upstream side secondary transfer roller 64 is arranged upstream side of the intermediate transfer section 40 in the rotational direction thereof. This upstream side secondary transfer roller 64 is capable of being in press contact with the belt drive roller 41 through the intermediate transfer section 40.

Among the pair of the secondary transfer rollers, the downstream side secondary transfer roller 65 is arranged at the downstream side of the recording medium F5 in the moving direction thereof. This downstream side secondary transfer roller 65 is capable of being in press contact to the recording medium F5 with the driven roller 44 through the intermediate transfer section 40.

Namely, intermediate transfer images which are formed on the intermediate transfer section 40 by overlaying the transferred monochromatic color images in a state that the recording medium F5 is in contact with the intermediate transfer section 40 which wound around the belt drive roller and the driven roller 44 and goes through between the driven roller 44 and the downstream side secondary transfer roller 65 and between the belt driven roller 41 and the upstream side secondary transfer roller 64 are secondary-transferred on the recording medium F5.

In this case, the belt driven roller 41 and the driven roller 44 have functions as backup rollers of the upstream side secondary transfer roller 64 and the downstream side secondary transfer roller 65, respectively. Namely, the belt driven roller 41 is also used as an upstream side backup roller arranged at the upstream side of the recording medium F5 to the driven roller 44 in the moving direction thereof in the secondary transfer unit 60. The driven roller 44 is also used as a downstream side backup roller arranged in the downstream side of the recording medium F5 to the belt driven roller 41 in the moving direction thereof in the secondary transfer unit 60.

The recording medium F5 which have been conveyed to the secondary transfer unit 60 is allowed to adhere to the intermediate transfer belt (intermediate transfer section 40) at positions between the upstream side secondary transfer roller 64 and the belt driven roller 41 (nip starting position) and between the downstream side secondary transfer roller 65 and the driven roller 44 (nip ending position). Since this makes it possible to secondary-transfer the intermediate transfer images of a full color on the intermediate transfer section 40 to the recording medium F5 with adhesion to the intermediate transfer section 40 for a predetermined period of time, it is possible to secondary-transfer the intermediate images reliably.

The secondary transfer unit 60 is provided with a secondary transfer roller cleaning blade 66 and a developer collecting section 67 with respect to the upstream side secondary transfer roller 64. The secondary transfer unit 60 is also provided with a secondary transfer roller cleaning blade 68 and a developer collecting section 69 with respect to the downstream side secondary transfer roller 65. Each of the secondary transfer roller cleaning blades 66 and 68 is in contact with the respective secondary transfer rollers 64 and 65 to clean them. Namely, after the completion of the secondary-transfer, the liquid developer remaining on the surfaces of each of the secondary transfer rollers 64 and 65 is scrapped off by the secondary transfer roller cleaning blades 66 and 68 and removed from the secondary transfer rollers 64 and 65. The liquid developer scrapped off from the surfaces of each of the respective secondary transfer rollers 64 and 65 by each of the secondary transfer roller cleaning blades 66 and 68 is collected and preserved by each of the developer collecting sections 67 and 69.

A toner image (transferred image) F5a transferred onto the recording medium F5 by the secondary transfer section 60 is fed to a fixing unit (fixing device) F40 to heat and press it, where the unfixed toner image is fixed onto the recoding medium F5.

In this regard, a fixing temperature (setting temperature), specifically, is preferably in the range of 80° C. or higher but 160° C. or lower, more preferably in the range of 100° C. or higher but 150° C. or lower, and even more preferably in the range of 100° C. or higher but 140° C. or lower.

Hereinbelow, detailed description will be made with regard to the developing units 100Y, 100M, 100C and 100K. In this regard, it is to be noted that since the developing units 100Y, 100M, 100C and 100K have the same structure, in the following description the developing section 100Y will be representatively described.

As shown in FIG. 2, the developing unit 100Y includes a liquid developer storage section 31Y, an application roller 32Y, a regulating blade 33Y, a liquid developer stirring roller 34Y, a communicating section 35Y, a collecting screw 36Y, a developing roller 20Y, and a developing roller cleaning blade 21Y.

The liquid developer storage section 31Y is provided with a function of storing the liquid developer for developing the latent image formed on the photoreceptor 10Y. Such a liquid developer storage section 31Y includes a supply section 31aY for supplying the liquid developer onto the application roller 32Y, a collecting section 31bY for collecting an excess liquid developer in the supply section 31aY, the developer collecting section 15Y and a developer collecting section 24Y and a partition 31cY for partitioning between the supply section 31aY and the collecting section 31bY.

The supply section 31aY has a function of supplying the liquid developer onto the application roller 32Y and has a concave portion in which a liquid developer stirring roller 34Y is provided. Further, the liquid developer is supplied from a liquid developer mixing bath 93Y into the supply section 31aY through the communication portion 35Y.

The collecting section 31bY is provided for collecting the liquid developer excessively supplied to the supply section 31aY and the excess liquid developer collected in the developer collecting sections 15Y and 24Y. The collected liquid developer is fed to the liquid developer mixing bath 93Y as described later and it is then reused. Further, the collecting section 31bY has a concave portion in which the collecting screw 36Y is provided in the vicinity of a bottom thereof.

A wall-like partition 31cY is provided between the supply section 31aY and the collecting section 31bY. The wall-like partition 31cY can partition between the supply section 31aY and the collecting section 31bY. And the partition 31cY can prevent the liquid developer collected in the developer collecting sections 15Y and 24Y from being mixed to the flesh liquid developer in the supply section 31aY. When the liquid developer is excessively supplied from the liquid developer mixing bath 93Y to the supply section 31aY, the excess liquid developer is spilled from the supply section 31aY into the collecting section 31bY over the partition 31cY. Therefore, it is possible to maintain a constant amount of the liquid developer in the supply section 31aY, thereby maintaining a constant amount of the liquid developer to be supplied to the application roller 32Y. As a result, it becomes possible to provide a constant image quality of the finally obtained images.

Further, a notch is provided in the partition 31cY. The liquid developer in the supply section 31aY can spill from the supply section 31aY into the collecting section 31bY over the notch.

The application roller 32Y has a function of supplying the liquid developer to the developing roller 20Y.

The application roller 32Y is of the type so-called as “Anilox Roller” which is constructed from a metallic roll made of iron or the like of which surface has grooves formed regularly and helically, and a nickel plating formed on the surface. The diameter of the roller is about 25 mm. In this embodiment, a number of grooves are formed inclinedly with respect to the rotational direction of the application roller 32Y by means of a cutting process or rolling process. The application roller 32Y rotates in an anti-clockwise direction and makes contact with the liquid developer so that the liquid developer stored in the supply section 31aY of the liquid developer storage section 31Y is carried by the grooves, and the carried liquid developer is then conveyed to the developing roller 20Y.

The regulating blade 33Y is provided in contact with the surface of the application roller 32Y for regulating an amount of the liquid developer carried on the application roller 32Y. Specifically, the regulating blade 33Y scrapes away an excess amount of the liquid developer on the application roller 32Y so that an amount of the liquid developer to be supplied onto the developing roller 20Y by the application roller 32Y can be regulated. The regulating blade 33Y is formed from an elastic body made of an urethane rubber, and supported by a regulating blade supporting member made of a metal such as iron or the like. Further, the regulating blade 33Y is arranged on the side where the application roller 32Y comes out of the liquid developer with its rotation (that is, on the right side in FIG. 2). In this regard, it is to be noted that the rubber hardness of the regulating blade 33Y, that is, a rubber hardness (77) of a portion of the regulating blade 33Y which in press contact with the surface of the application roller 32Y is about 77 according to JIS-A. The rubber hardness (77) of the regulating blade 33Y is lower than the rubber hardness of an elastic layer of the developing roller 20Y (described later) which is a rubber hardness (about 85) of a portion of the developing roller 20Y which is in press contact with the surface of the application roller 32Y. Further, the excess amount of the liquid developer scraped off by the regulating blade 33Y is collected in the supply section 31aY and it is then reused.

The liquid developer stirring roller 34Y has a function of stirring the liquid developer so as to be homogeneously dispersed. By providing such a liquid developer stirring roller 34, even when the toner particles are aggregated in the supply section 31a, it is possible to disperse the toner particles preferably.

Further, the acrylic modified silicone as the substance A, which is sufficiently soluble to the insulation liquid, is contained in the liquid developer. Therefore, it is possible to obtain absolutely the excellent dispersion stability of the toner particles in the liquid developer. This makes it possible to lower voltage to be applied to the liquid developer stirring roller, thereby enabling electric power saving of the image formation apparatus to be assisted.

In the supply section 31aY, the toner particles of the liquid developer are positively charged. The liquid developer is stirred by the liquid developer stirring roller 34Y to be a homogeneously dispersed state, and such a liquid developer is dipped from the supply section 31aY according to the rotation of the application roller 32Y so that the liquid developer is supplied onto the developing roller 20Y with the amount of the liquid developer being regulated by the regulating blade 33Y. Further, the stirring by the liquid developer stirring roller 34Y makes it possible to reliably supply the liquid developer in the supply section 31aY to the collecting section 31bY over the wall-like partition 31cY. Therefore, it is possible to prevent an excess amount of the liquid developer from remaining in the supply section 31aY. It is also possible to prevent the toner particles contained in the liquid developer from aggregating in the supply section 31aY.

Furthermore, the liquid developer stirring roller 34Y is provided in the supply section 31aY in the vicinity of the communicating section 35Y. Therefore, it is possible to quickly diffuse the liquid developer supplied from the liquid developer mixing bath 93Y through the communicating section 35Y. As a result, even in the case where the liquid developer is being supplied from the liquid developer mixing bath 93Y to the supply section 31aY, it is possible to maintain the stable surface of the liquid developer in the supply section 31aY. Since such a liquid developer stirring roller 34Y is provided in the supply section 31aY in the vicinity of the communicating section 35Y, a pressure in the supply section 31aY is lower than a pressure in the liquid developer mixing bath 93Y. Therefore, the liquid developer is naturally supplied from the liquid developer mixing bath 93Y to the supply section 31aY through the communicating section 35Y.

The communicating section 35Y is provided below the liquid developer stirring roller 34Y in the liquid developer storage section 31Y. Further, the communicating section 35Y is in communication with the liquid developer mixing bath 93Y through feeding means. The communicating section 35Y is a part through which the liquid developer is supplied from the liquid developer mixing bath 93Y to the supply section 31aY.

Since the communicating section 35Y is provided below the liquid developer stirring roller 34Y in the liquid developer storage section 31, it is difficult for the liquid developer to enter into the supply section 31aY through the communicating section 35Y. Therefore, no ruffle is observed on the surface of the liquid developer by the reverse flow of the liquid developer thorough the communicating section 35Y. As a result, it is possible to maintain the stable surface of the liquid developer in the supply section 31aY, thereby enabling the liquid developer to be supplied to the application roller 32Y reliably.

The collecting screw 36Y which is provided in the vicinity of the bottom of the collecting section 31bY is made of a cylindrical member and has a helically rib on a outer circumferential thereof. Further, the collecting screw 36Y has a function of keeping fluidity of the liquid developer collected from the developer collecting sections 15Y and 24Y. Furthermore, the collecting screw 36Y also has a function of facilitating supply of the liquid developer to the liquid developer mixing bath 93Y.

The developing roller 20Y is provided for conveying the liquid developer to a developing position opposed to the photoreceptor 10Y in order to develop a latent image carried on the photoreceptor 10Y with the liquid developer.

The liquid developer from the application roller 32Y is supplied onto the surface of the developing roller 20Y so that a layer of the liquid developer is formed on the surface.

The developing roller 20Y includes an inner core member made of a metal such as iron or the like and an elastic layer having conductivity and provided onto an outer periphery of the inner core member. The diameter of the developing roller 20Y is about 20 mm. The elastic layer has a two layered structure which includes an inner layer made of urethane rubber and an outer layer (surface layer) made of urethane rubber. The inner layer has a rubber hardness of 30 according to JIS-A and a thickness of about 5 mm, and the outer layer has a rubber hardness of about 85 according to JIS-A and a thickness of about 30 μm. The developing roller 20Y is in press contact with both the application roller 32Y and the photoreceptor 10Y in a state that the outer layer of the developing roller 20Y is elastically deformed.

The developing roller 20Y is rotatable about its central axis, and the central axis is positioned below the central axis of the photoreceptor 10Y. Further, the developing roller 20Y rotates in a direction (clockwise direction in FIG. 2) opposite to the rotational direction (anti-clockwise direction in FIG. 2) of the photoreceptor 10Y. It is to be noted that an electrical field is generated between the developing roller 20Y and the photoreceptor 10Y when a latent image formed on the photoreceptor 10Y is developed.

In this regard, it is to be noted that the application roller 32Y and developing roller 20Y are driven by a different power source (not shown) with each other in the developing unit 100Y, respectively. Therefore, by changing a rotational speed (linear velocity) ratio of the application roller 32Y and the developing roller 20Y, it is possible to adjust an amount of the liquid developer to be supplied onto the developing roller 20Y.

The developing unit 100Y has a developing roller cleaning blade 21Y made of rubber and provided in contact with the surface of the developing roller 20Y and a developer collecting section 24Y. The developing roller cleaning blade 21Y is a device for scrapping off the liquid developer remaining on the developing roller 20Y after the development of an image has been carried out at the developing position. The liquid developer removed by the developing roller cleaning blade 21Y is collected in the developer collecting section 24Y.

As shown in FIG. 1 and FIG. 2, the image forming apparatus 1000 is provided with liquid developer supply sections 90Y, 90M, 90C and 90K which supply the liquid developers to the developing sections 30Y, 30M, 30C and 30K, respectively. The liquid developer supply sections 90Y, 90M, 90C and 90K have the same structure, respectively. Namely, the liquid developer supply sections 90Y, 90M, 90C and 90K are provided with liquid developer tanks 91Y, 91M, 91C and 91K, insulation liquid tanks 92Y, 92M, 92C and 92K and liquid developer mixing baths 93Y, 93M, 93C and 93K, respectively.

In each of the liquid developer tanks 91Y, 91M, 91C and 91K, a liquid developer of high concentration which corresponds to each of the different colors is stored. Further, in each of the insulation liquid tanks 92Y, 92M, 92C and 92K, the insulation liquid is stored. Further, each of the liquid developer mixing baths 93Y, 93M, 93C and 93K is constructed so that a predetermined amount of the high concentration liquid developer is supplied from each of the corresponding liquid developer tanks 91Y, 91M, 91C and 91K and a predetermined amount of the insulation liquid is supplied from each of the corresponding insulation liquid tanks 92Y, 92M, 92C and 92K.

In each of the liquid developer mixing baths 93Y, 93M, 93C and 93K, the supplied high concentration liquid developer and the supplied insulation liquid are mixed by a provided stirring device with being stirred to prepare the liquid developers corresponding to different colors which are to be used in the supply sections 31aY, 31aM, 31aC and 31aK, respectively. The liquid developers prepared in the respective liquid developer mixing baths 93Y, 93M, 93C and 93K in this way are supplied to the corresponding supply sections 31aY, 31aM, 31aC and 31aK, respectively. Further, the liquid developers collected in the respective collecting sections 31bY, 31bM, 31bC and 31bK are respectively collected to the liquid developer mixing baths 93Y, 93M, 93C and 93K and then they are reused.

As described above, the liquid developer supplied to each developing section is obtained by mixing the high concentration liquid developer and the insulation liquid. Here, generally, if a concentration of the liquid developer becomes high, the toner particles in the liquid developer tend to aggregate with ease. However, the liquid developer of the invention exhibits an excellent effect of preventing the aggregation of the toner particles. Therefore, in the case where the high concentration liquid developer is used to the invention, regardless of a high ratio of the toner particles, it is possible to reliably prevent the toner particles from being aggregated. As a result, it is possible to bring the high concentration liquid developer to be stored in each tank in further high concentration, consequently it is possible downsize each tank to store the high concentration liquid developer. Further, since the liquid developer of the invention has excellent affinity with respect to the insulation liquid, when the high concentration liquid developer used to the invention and the insulation liquid are mixed with each other in each mixing bath, the high concentration liquid developer and the insulation liquid can be mixed with each other promptly and uniformly. Therefore, it becomes possible to simplify and downsize each mixing bath and the stirring device. Consequently, it is possible to simplify and downsize the whole of the image forming apparatus.

Further, the image formation using the apparatus is performed with a developing step, a transfer step and a fixing step. The developing step is to form a plurality of monochromatic color images corresponding to the respective colors on the developing rollers 10Y, 10M, 10C, 10K by using a plurality of liquid developer each having different colors (liquid developer of the invention). The transfer step is to transfer the plurality of monochromatic color images formed on the developing rollers onto the recording medium F5 to form an unfixed toner image formed by overlaying the plurality of monochromatic color images on the recording medium F5. The fixing step is to fix the unfixed toner image onto the recording medium F5. By using such a method, it is possible to easily form images having good color development.

In the foregoing, the invention has been described based on the preferred embodiments, but the invention is not limited to these embodiments.

For example, the liquid developer of the invention is not limited to one that is to be used in the image forming apparatuses as described above.

Further, the method of producing the liquid developer of the invention may include any steps in addition to the steps described above (the wet grinding step, the heating step and the mixing step). For example, after the wet grinding step (between the wet grinding step and the heating step, between the heating step and the mixing step, or after the mixing step), the method may include a step of mixing an insulation liquid of a different component from that of the insulation liquid used in the wet grinding step. In other words, the component of the insulation liquid used in the wet grinding step may be different from the component of the insulation liquid constituting the finally obtained liquid developer. Inclusion of such a step makes it possible to obtain a liquid developer of excellent composition finally with providing with high treatment efficiency of the wet grinding step.

### EXAMPLES

### 1 Production of Substance A

First, prior to a production of a liquid developer, a substance A was synthesized.

### Synthetic Example 1

A synthetic process of the substance A was performed as follows. First, isopropanol of 120 g, each of radical polymerization monomers of methyl methacrylate of 20 g, buthyl methacrylate of 5 g and 2-ethylhexyl methacrylate of 5 g, and a silicone macromere represented by the following formula (4) of t-butylperoxy-2-ethylhexanoate of 4 g were added to a glass flask provided with a stirring machine, a thermometer and a reflux condenser to obtain a mixture. The mixture was heated to reflux with stirring under the current of nitrogen gas. Thereafter, these compounds were polymerized with each other for 5 hours to obtain an acrylic modified silicone as the substance A by distilling away a volatile element under the reduced pressure.

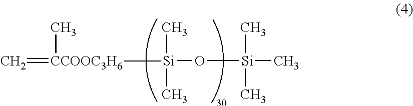

### Synthetic Examples 2 to 4

In each of the Synthetic Examples 2 to 4, an acrylic modified silicone as the substance A was obtained in the same manner as in the Synthetic Example 1, except the components to be used for synthesizing the substance A were changed as shown in Table 1.

The components and the amounts used in each of the Synthetic Examples 2 to 4 are shown in Table 1.

TABLE 1

| | | Component amounts of | | | |
|---|---|---|---|---|---|
| | | acrylic modified silicone (g) | | | |
| | | Synthetic | Synthetic | Synthetic | Synthetic |
| | | Example 1 | Example 2 | Example 3 | Example 4 |
| Silicone macromeres | Formula (4) | 70 | — | 70 | — |
| | Formula (5) | — | 40 | | — |
| | Formula (6) | — | — | — | 50 |
| Radical | Methyl methacrylate | 20 | 30 | 20 | 10 |
| polymerization | Buthyl methacrylate | 5 | 15 | 4 | 30 |
| monomers | 2-ethylhexyl methacrylate | 5 | 15 | 4 | 8 |
| | Dimethyl | — | — | 2 | — |
| | aminoethyl methacrylate | | | | |
| | Methacryloyl aminopropyl | — | — | — | 2 |
| | trimethyl ammonium chloride | | | | |

| | | | | |
|---|---|---|---|---|
| X1/X2 | 2.33 | 0.67 | 2.33 | 1.00 |

The formula (5) and formula (6) shown in Table 1 are represented by the following chemical formula, respectively.

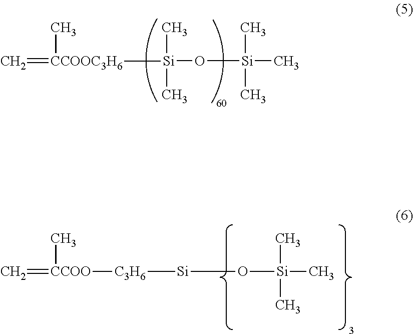

### 2 Preparation of Solution of Substance A

### Preparation Example 1

The acrylic modified silicone as the substance A obtained in the Synthetic Example 1 was diluted by decamethyl cyclopenta siloxane of an insulation liquid to prepare an acrylic modified silicone solution of 30 wt %.

### Preparation Examples 2 to 4

In the Preparation Examples 2 to 4, an acrylic modified silicone solution was obtained in the same manner as in the Preparation Example 1, except the substance A obtained in each of the Synthetic Examples 2 to 4 was used instead of the substance A obtained in the Synthetic Example 1.

### 3 Production of Liquid Developer

Next, a liquid developer was produced as follows. Some steps in which temperatures were not described were performed at room temperature (25° C.).

### Example 1

Kneading step and Coarsely Grinding step

Preparation of Coloring Agent Master Batch

First, 60 parts by weight of polyester resin (a glass transition temperature (Tg) thereof was 50° C.) as a resin material were prepared.

Next, a mixture (weight ratio 50:50) of the resin material and a cyan type pigment (“Pigment Blue 15:3” produced by Dainichiseika Color & Chemicals Mfg. Co., Ltd.) as a coloring agent was prepared. These components were mixed by using a 20 L type Henschel mixer to obtain a material for producing toner particles.

Next, a raw material (mixture) was kneaded by using a biaxial kneader-extruder. A kneaded material extruded from an extruding port of the biaxial kneader-extruder was cooled.

The kneaded material that had been cooled as described above was coarsely ground by using a hammer mill to be formed into powder constituting a coloring agent master batch which had an average particle size of 1.0 mm or less. In this way, the coloring agent master batch was obtained.

Preparation of Coarsely Ground Material

The coloring agent master batch of 15 parts by weight and the polyester resin of 85 parts by weight were kneaded by using the biaxial kneader-extruder. A kneaded material extruded from the extruding port of the biaxial kneader-extruder was cooled. The obtained kneaded material was coarsely ground by using the hammer mill to obtain a coarsely ground material.

Wet Grinding Step

The coarsely ground material obtained by the above steps, the acrylic modified silicone solution as the substance A obtained in the Preparation Example 1, a quaternary cation silicone (“Silsense Q-Plus” produced by The Lubrizol Corporation) as the Substance C, and a dimethyl silicone oil (“KF-96-50 cs” produced by Shin-Etsu Chemical Co., Ltd.) as the insulation liquid were added into a pot made of ceramics (a volume of 600 ml). Further, zirconia balls (diameter: 10 mm) were also added thereinto so that a filling ratio in volume of the zirconia balls became 40%. The coarsely ground material was wet-ground for 48 hours at a rotating velocity of 230 rpm with a desk pot mill.

With regard to particles included in a dispersion liquid obtained by performing the present step, an average roundness R₀ of the particles was measured. As a result, the average roundness R₀ was 0.860.

Heating Step

The dispersion liquid obtained in the wet grinding step was added into a beaker to heat it at a temperature of 60° C. on a hot stirrer. At that time, shear force of 500 rpm was given to the dispersion liquid. The heating treatment was performed for 30 minutes. Then, the dispersion liquid was naturally cooled by room temperature.

An average roundness R₁ of the particles included in the dispersion liquid after the present step was 0.905.

Mixing Step

Thereafter, 10 parts by weight of trimethyl siloxy silicic acid (“SS4267” produced by Momentive) as the Substance B were added to the dispersion liquid which was subjected to the above heating treatment to obtain a mixture. The mixture was mixed and stirred by a “disper stirring device” to obtain a liquid developer. An average diameter in volume (D50) of the toner particles was 3.0 μm.

### Examples 2 to 17

In each of the Examples 2 to 17, a liquid developer was produced in the same manner as in the Example 1, except that the components to be used for producing the liquid developer and the amounts thereof and the conditions of the heating treatment in the heating step were changed as shown in Table 2.

### Example 18

A liquid developer was produced in the same manner as in the Example 1, except that components to be used for producing the liquid developer and amounts thereof were changed as shown in Table 3 and the conditions of the grinding step were changed as follows.

In the grinding step, the wet grinding using the zirconia balls was changed to a wet grinding using a beads mill. Such a step made it possible to suppress a viscosity of the coloring agent master batch from increasing during the grinding step regardless of the high concentration of the coloring agent master batch. Consequently, particles of about 3 μm were obtained.

An average roundness R₀ of the particles included in the dispersion liquid before the heating step was 0.860. Further, an average roundness R₁ of the toner particles included in the obtained liquid developer was 0.912.

### Example 19

A liquid developer was produced in the same manner as in the Example 18, except that the materials to be used for producing the liquid developer and the amounts thereof were changed as shown in Table 3.

### Example 20

Kneading step and Coarsely Grinding step

Preparation of Coloring Agent Master Batch

First, 60 parts by weight of a polyester resin (a glass transition temperature (Tg) thereof was 50° C.) as a resin material were prepared.

Next, a mixture (weight ratio 50:50) of the resin material and a cyan type pigment (“Pigment Blue 15:3” produced by Dainichiseika Color & Chemicals Mfg. Co., Ltd.) as a coloring agent was prepared. These components were mixed by using a 20 L type Henschel mixer to obtain a raw material for producing toner particles.

Next, the raw material (mixture) was kneaded by using a biaxial kneader-extruder. A kneaded material extruded from an extruding port of the biaxial kneader-extruder was cooled.

The kneaded material that had been cooled as described above was coarsely ground by using a hammer mill to be formed into powder constituting a coloring agent master batch which had an average particle size of 1.0 mm or less. In this way, the coloring agent master batch was obtained.

Preparation of Coarsely Ground Material

The coloring agent master batch of 15 parts by weight and the polyester resin of 85 parts by weight were kneaded by using the biaxial kneader-extruder. A kneaded material extruded from the extruding port of the biaxial kneader-extruder was cooled. The obtained kneaded material was coarsely ground by using the hammer mill to obtain a coarsely ground material.

Wet Grinding Step

The coarsely ground material obtained by the above process, the acrylic modified silicone solution as the substance A obtained in the Preparation Example 1, the quaternary cation silicone (“Silsense Q-Plus” produced by The Lubrizol Corporation) as the Substance C, trimethyl siloxy silicic acid (“SS4267” produced by Momentive) as the substance B and the dimethyl silicone oil (“KF-96-50 cs” produced by Shin-Etsu Chemical Co., Ltd.) as the insulation liquid were added into a pot made of ceramics (a volume of 600 ml). Further, zirconia balls (diameter: 10 mm) were also added thereinto so that a filling ratio in volume of the zirconia balls became 40%. The coarsely ground material was wet-ground for 48 hours at a rotating velocity of 230 rpm with a desk pot mill.

With regard to particles included in a dispersion liquid obtained by performing the present step, an average roundness R₀ of the particles was measured by using FPIA-3000S. As a result, the average roundness R₀ was 0.860.

Heating Step

The dispersion liquid obtained in the wet grinding step was added into a beaker to heat it at a temperature of 60° C. on a hot stirrer. At that time, shear force of 500 rpm was given to the dispersion liquid. The heating treatment was performed for 30 minutes. Then, the dispersion liquid was naturally cooled by room temperature.

An average roundness R₁ of the particles included in the obtained liquid developer was 0.912.

### Examples 21 to 25

In each of the Examples 21 to 25, a liquid developer was produced in the same manner as in the Example 20, except that the components to be used for producing the liquid developer and the amounts thereof and the conditions of the heating treatment in the heating step were changed as shown in Table 3.

### Comparative Examples 1 to 3

In the Comparative Examples 1 to 3, a liquid developer was produced in the same manner as in the Example 1, except that an insoluble acrylic modified silicone was used instead of the substance A in the wet grinding step.

### Comparative Example 4

A liquid developer was produced in the same manner as in the Example 1, except that KF393 (produced by Shin-Etsu Chemical Co., Ltd.) was used as an amino modified silicone sufficiently soluble to the insulation liquid (not acrylic modified silicone) instead of the substance A in the wet grinding step and the amounts of the components were changed as shown in Table 3.

### Comparative Example 5

A liquid developer was produced in the same manner as in the Example 1, except that the substance A was not used in the wet grinding step and the amounts of the components were changed as shown in Table 3.

### Comparative Example 6

A liquid developer was produced in the same manner as in the Example 1, except that the substance A and the substance C were not used in the wet grinding step and the amounts of the components were changed as shown in Table 3.

### Comparative Example 7

A liquid developer was produced in the same manner as in the Example 1, except that the heating step was omitted.

### Comparative Example 8

A liquid developer was produced in the same manner as in the Example 20, except that that an acrylic modified silicone sufficiently insoluble to the insulation liquid was used as the substance A in the wet grinding step.

### Comparative Example 9

A liquid developer was produced in the same manner as in the Example 20, except that the substance A was not used in the wet grinding step and the amounts of the components were changed as shown in Table 3.

### Comparative Example 10

A liquid developer was produced in the same manner as in the Example 20, except that the substance B and the substance C were not used in the wet grinding step and the components and the amounts thereof were changed as shown in Table 3.

### Comparative Example 11

A liquid developer was produced in the same manner as in the Example 20, except that the heating step was omitted.

### Comparative Example 12

A liquid developer was produced in the same manner as in the Example 1, except that an insoluble acrylic modified silicone was used instead of the substance A in the wet grinding step, the amounts of the components were changed as shown in Table 3, and the conditions of the grinding step were changed as follows.

In the grinding step, the wet grinding using the zirconia balls was changed to a wet grinding using a beads mill in the same manner as in the Example 18.

The components and the production conditions of the liquid developer obtained in each of the Examples and the Comparative Examples are shown in Table 2 and Table 3.

In this regard, the roundness of the toner particles included in the liquid developer obtained in each of the Examples and the Comparative Examples were measured as follows. In each of the Examples and the Comparative Examples, a silicone oil (viscosity of 2 cst) was added into the obtained dispersion liquid and the obtained liquid developer to dilute 10-fold on a basis of volume. Furthermore, they were subjected to an ultrasonic treatment for 1 minute to disperse the toner particles. Consequently, a dilution liquid was obtained. The obtained dilution liquid was subjected to a flow-type particle size analyzer (“FPIA-3000S” produces by Sysmex Corporation) to measure the roundness of the toner particles.

Further, in Tables, it is to be noted that the polyester resin (a glass transition temperature (Tg) thereof was 50° C.) is shown as “PES1”, the polyester resin (a glass transition temperature (Tg) thereof was 60° C.) is shown as “PES2”, the styrene-acrylate resin (a glass transition temperature (Tg) thereof was 50° C.) is shown as “StAc1”, the styrene-acrylate resin (a glass transition point (Tg) thereof was 60° C.) is shown as “StAc2”, the acrylic modified silicone as the substance A synthesized according to the amounts of component in the Synthetic Example 1 of Table 1 is shown as “A1”, the acrylic modified silicone as the substance A synthesized according to the amounts of component in the Synthetic Example 2 of Table 1 is shown as “A2”, the acrylic modified silicone as the substance A synthesized according to the amounts of component in the Synthetic Example 3 of Table 1 is shown as “A3”, the acrylic modified silicone as the substance A synthesized according to the amounts of component in the Synthetic Example 4 of Table 1 is shown as “A4”, solid parts of the insoluble acrylic modified silicone (“FA40021D” produced by Dow Corning Toray Co., Ltd.) is shown as “A′1”, solid parts of the insoluble acrylic modified silicone (“KP575” produced by Shin-Etsu Chemical Co., Ltd.) is shown as “A′2”, solid parts of the insoluble acrylic modified silicone (“FA40001CM”, cyclopenta siloxane dissolution silicone, produced by Dow Corning Toray Co., Ltd.) is shown as “A′3”, solid parts of the soluble amino modified silicone (“KF393”, produced by Shin-Etsu Chemical Co., Ltd.) is shown as “A′4”, trimethyl siloxy silicic acid as the substance B (“SS4267” produced by Momentive) is shown as “B1”, tetra(trimethyl siloxy) silane as the substance B (“DC593” produced by Dow Corning Toray Co., Ltd.) is shown as “B2”, trimethyl siloxy silicic acid as the substance B (“KF7312J” produced by Shin-Etsu Chemical Co., Ltd.) is shown as “B3”, the fluoro modified silicone as the substance B (“XS66-B8226” produced by Momentive) is shown as “B4”, the fluoro modified silicone as the substance B (“XS66-C1191” produced by Momentive) is shown as “B5”, the fluoro modified silicone as the substance B (“XS66-B8636” produced by Momentive) is shown as “B6”, the quaternary cation silicone as the substance C (“Silsense Q-Plus” produced by The Lubrizol Corporation) is shown as “C1”, the aminopropyl phenyl trimethicone as the substance C (“2-2078 Fluid” produced by Dow Corning Toray Co., Ltd.) is shown as “C2”, the phenyl modified silicone as the substance C (“SH556” produced by Dow Corning Toray Co., Ltd.) is shown as “C3”, the phenyl modified silicone as the substance C (“Silshine 151” produced by Momentive) is shown as “C4”, the phenyl modified silicone as the substance C (“PH1555” produced by Dow Corning Toray Co., Ltd.) is shown as “C5”, the method of performing the kneading step, the coarsely grinding step, the wet grinding step, the heating step and the mixing step in this order is shown as “M1”, the method of performing the kneading step, the coarsely grinding step, the wet grinding step and the heating step in this order is shown as “M2”, and the method of performing the kneading step, the coarsely grinding step and the wet grinding step in this order is shown as “M3”.

Further, the average roundness R₀ of the particles included in the dispersion liquid in the heating step of each of the Examples was in the range of 0.800 or more but 0.889 or less. The average roundness R₁ of the toner particles included in the liquid developer obtained in each of the Examples was in the range of 0.900 or more but 0.960 or less.

Further, a solubility of the soluble acrylic modified silicone with respect to the insulation liquid of 100 g at 25° C., which is obtained in each of the Examples, was 10 g or higher.

In this regard, the conditions of the insoluble acrylic modified silicone or the soluble amino modified silicone were shown in the columns of the substance A of Table 2 and Table 3 in the Comparative Examples 1 to 4, the Comparative Example 8 and the Comparative Example 12.

TABLE 2

| | Composition of liquid developer | | | | | | | | | | | | | | |
|---|---|---|---|---|---|---|---|---|---|---|---|---|---|---|---|
| | | | | | Insula- | | | | | | | | | | |
| | Toner base particles | | | | tion | | | | | | | | Conditions of | | |
| | Resin material | | | Coloring | liquid | Substance A | | Substance B | | Substance C | | | heating treatment | | |
| | | Amount | | agent | Amount | | Amount | | Amount | | Amount | | Heating | | Rota- |
| | | [Parts | | Amount | [Parts | | [Parts | | [Parts | | [Parts | | temper- | Heating | tion |
| | | by | Tg | [Parts | by | | by | | by | | by | | ature | time | speed |
| | Kind | weight] | [° C.] | by weight] | weight] | Kind | weight] | Kind | weight] | Kind | weight] | Method | [° C.] | [minute] | [rpm] |
| Ex. 1 | PES1 | 20.0 | 50.0 | 15.0 | 74.9 | A1 | 2.5 | B1 | 2.5 | C1 | 0.1 | M1 | 60 | 30 | 500 |
| Ex. 2 | PES1 | 20.0 | 50.0 | 15.0 | 74.9 | A1 | 2.5 | B1 | 2.5 | C1 | 0.1 | M1 | 60 | 30 | 500 |
| Ex. 3 | PES1 | 20.0 | 50.0 | 15.0 | 75.0 | A3 | 2.5 | B1 | 2.5 | — | — | M1 | 60 | 30 | 500 |
| Ex. 4 | PES1 | 20.0 | 50.0 | 15.0 | 75.0 | A4 | 2.5 | B1 | 2.5 | — | — | M1 | 60 | 30 | 500 |
| Ex. 5 | StAc1 | 20.0 | 50.0 | 15.0 | 77.9 | A1 | 1.0 | B1 | 1 | C1 | 0.1 | M1 | 60 | 30 | 500 |
| Ex. 6 | StAc2 | 20.0 | 60.0 | 15.0 | 77.9 | A1 | 1.0 | B1 | 1 | C1 | 0.1 | M1 | 60 | 30 | 500 |
| Ex. 7 | PES1 | 20.0 | 50.0 | 15.0 | 75.0 | A3 | 2.5 | B1 | 2.5 | — | — | M1 | 60 | 30 | 500 |
| Ex. 8 | StAc1 | 20.0 | 50.0 | 15.0 | 77.9 | A1 | 1.0 | B4 | 1 | C1 | 0.1 | M1 | 60 | 30 | 500 |
| Ex. 9 | PES1 | 20.0 | 50.0 | 15.0 | 74.6 | A1 | 2.5 | B1 | 2.5 | C2 | 0.4 | M1 | 60 | 30 | 500 |
| Ex. 10 | PES1 | 20.0 | 50.0 | 15.0 | 74.6 | A1 | 2.5 | B1 | 2.5 | C3 + C5 | 0.4 | M1 | 60 | 30 | 500 |
| Ex. 11 | PES1 | 20.0 | 50.0 | 15.0 | 74.6 | A1 | 2.5 | B1 | 2.5 | C4 | 0.4 | M1 | 60 | 30 | 500 |
| Ex. 12 | PES1 | 20.0 | 50.0 | 15.0 | 74.9 | A1 | 2.5 | B2 | 2.5 | C1 | 0.1 | M1 | 60 | 30 | 500 |
| Ex. 13 | PES1 | 20.0 | 50.0 | 15.0 | 74.9 | A1 | 2.5 | B3 | 2.5 | C1 | 0.1 | M1 | 60 | 30 | 500 |
| Ex. 14 | PES1 | 20.0 | 50.0 | 15.0 | 74.9 | A1 | 2.5 | B4 | 2.5 | C1 | 0.1 | M1 | 60 | 30 | 500 |
| Ex. 15 | PES1 | 20.0 | 50.0 | 15.0 | 74.9 | A1 | 2.5 | B5 | 2.5 | C1 | 0.1 | M1 | 60 | 30 | 500 |
| Ex. 16 | PES1 | 20.0 | 50.0 | 15.0 | 74.9 | A1 | 2.5 | B6 | 2.5 | C1 | 0.1 | M1 | 60 | 30 | 500 |
| Ex. 17 | PES2 | 20.0 | 60.0 | 15.0 | 74.9 | A1 | 2.5 | B1 | 2.5 | C1 | 0.1 | M1 | 60 | 30 | 500 |

TABLE 3

| | Composition of liquid developer | | | | | | | | | | | | | | |
|---|---|---|---|---|---|---|---|---|---|---|---|---|---|---|---|
| | | | | | Insula- | | | | | | | | | | |
| | Toner base particles | | | | tion | | | | | | | | Conditions of | | |
| | Resin material | | | Coloring | liquid | Substance A | | Substance B | | Substance C | | | heating treatment | | |
| | | Amount | | agent | Amount | | Amount | | Amount | | Amount | | Heating | | Rota- |
| | | [Parts | | Amount | [Parts | | [Parts | | [Parts | | [Parts | | temper- | Heating | tion |
| | | by | Tg | [Parts | by | | by | | by | | by | | ature | time | speed |
| | Kind | weight] | [° C.] | by weight] | weight] | Kind | weight] | Kind | weight] | Kind | weight] | Method | [° C.] | [minute] | [rpm] |
| Ex. 18 | PES1 | 30.0 | 50.0 | 15.0 | 64.9 | A1 | 3.8 | B1 | 3.8 | C1 | 0.1 | M1 | 60 | 30 | 500 |
| Ex. 19 | PES1 | 35.0 | 50.0 | 15.0 | 60.0 | A3 | 4.4 | B1 | 4.4 | — | — | M1 | 60 | 30 | 500 |
| Ex. 20 | PES1 | 20.0 | 50.0 | 15.0 | 74.9 | A1 | 2.5 | B1 | 2.5 | C1 | 0.1 | M2 | 60 | 30 | 500 |
| Ex. 21 | PES2 | 20.0 | 60.0 | 15.0 | 74.9 | A1 | 2.5 | B1 | 2.5 | C1 | 0.1 | M2 | 60 | 30 | 500 |
| Ex. 22 | PES1 | 20.0 | 50.0 | 15.0 | 75.0 | A3 | 2.5 | B1 | 2.5 | — | — | M2 | 60 | 30 | 500 |
| Ex. 23 | PES1 | 20.0 | 50.0 | 15.0 | 74.9 | A1 | 2.5 | B4 | 2.5 | C1 | 0.1 | M2 | 60 | 30 | 500 |
| Ex. 24 | StAc1 | 20.0 | 55.0 | 15.0 | 77.9 | A1 | 1.0 | B1 | 1 | C1 | 0.1 | M2 | 60 | 30 | 500 |
| Ex. 25 | StAc2 | 20.0 | 60.0 | 15.0 | 77.9 | A1 | 1.0 | B4 | 1 | C1 | 0.1 | M2 | 60 | 30 | 500 |
| Com. Ex. 1 | PES1 | 20.0 | 50.0 | 15.0 | 74.9 | A′1 | 2.5 | B1 | 2.5 | C1 | 0.1 | M1 | 60 | 30 | 500 |
| Com. Ex. 2 | PES1 | 20.0 | 50.0 | 15.0 | 74.9 | A′2 | 2.5 | B1 | 2.5 | C1 | 0.1 | M1 | 60 | 30 | 500 |
| Com. Ex. 3 | PES1 | 20.0 | 50.0 | 15.0 | 74.9 | A′3 | 2.5 | B1 | 2.5 | C1 | 0.1 | M1 | 60 | 30 | 500 |
| Com. Ex. 4 | PES1 | 20.0 | 50.0 | 15.0 | 75.0 | A′4 | 2.5 | B1 | 2.5 | — | — | M1 | 60 | 30 | 500 |
| Com. Ex. 5 | PES1 | 20.0 | 50.0 | 15.0 | 74.9 | — | — | B1 | 5.0 | C1 | 0.1 | M1 | 60 | 30 | 500 |
| Com. Ex. 6 | PES1 | 20.0 | 50.0 | 15.0 | 75.0 | — | — | B1 | 5.0 | — | — | M1 | 60 | 30 | 500 |
| Com. Ex. 7 | PES1 | 20.0 | 50.0 | 15.0 | 74.9 | A1 | 2.5 | B1 | 2.5 | C1 | 0.1 | M3 | — | — | — |
| Com. Ex. 8 | PES1 | 20.0 | 50.0 | 15.0 | 74.9 | A′1 | 2.5 | B1 | 2.5 | C1 | 0.1 | M2 | 60 | 30 | 500 |
| Com. Ex. 9 | PES1 | 20.0 | 50.0 | 15.0 | 74.9 | — | — | B1 | 5.0 | C1 | 0.1 | M2 | 60 | 30 | 500 |
| Com. Ex. 10 | PES1 | 20.0 | 50.0 | 15.0 | 75.0 | A3 | 1.5 | — | — | — | — | M2 | 60 | 30 | 500 |
| Com. Ex. 11 | PES1 | 20.0 | 50.0 | 15.0 | 74.9 | A1 | 2.5 | B1 | 2.5 | C1 | 0.1 | M3 | — | — | — |
| Com. Ex. 12 | PES1 | 30.0 | 50.0 | 15.0 | 64.9 | A′1 | 2.5 | B1 | 2.5 | C1 | 0.1 | M1 | 60 | 30 | 500 |

### 3 Evaluation

The liquid developers obtained as described above were evaluated as follows.

3.0 Grinding Efficiency

In order to decide a gliding efficiency during a grinding time until reaching a predetermined average diameter in volume of the particles in the grinding step of each of the Examples and the Comparative Examples, the grinding time and the grinding efficiency were evaluated according to the following four criteria A to D.

A: The grinding time is less than 24 hours, so that the grinding efficiency is excellent.

B: The grinding time is for over 24 hours but less than hours, so that the grinding efficiency is slightly excellent.

C: The grinding time is for over 36 hours but less than hours, so that the grinding efficiency is slightly inferior.

D: The grinding time is for over 48 hours, so that the grinding efficiency is inferior.

3.1 Developing Efficiency

By using the image forming apparatus shown in FIG. 1 and in FIG. 2, a layer of the liquid developer was formed on the surface of the developing roller of the image forming apparatus using each of the liquid developers obtained in the Examples and the Comparative Examples. Next, in the image forming apparatus in which the layer of the liquid developer was formed, surface potential of the developing roller and surface potential of the photoreceptor were respectively electrified at a voltage of 300V and a voltage of 500V uniformly. Thereafter, the photoreceptor was exposed so that the surface potential of the photoreceptor was decreased to a voltage of 50V to form a latent image on the photoreceptor. Thereafter, the layer of the liquid developer formed on the surface of the developing roller was made to be passed between the developing roller and the photoreceptor so that a part of the toner particles of the liquid developer was transferred from the developing roller onto the photoreceptor to develop the latent image on the outer peripheral surface of the photoreceptor. Then, the toner particles remaining on the outer peripheral surface of the developing roller and the toner particles transferred on the outer peripheral surface of the photoreceptor were picked up by attaching adhesive tapes to the outer peripheral surface of the developing roller and the outer peripheral surface of the photoreceptor, respectively. Thereafter, the adhesive tapes carrying the toner particles thereon were attached to recording papers so as to transfer the toner particles to each of the recording papers. And then, an amount of the toner particles attached to each of the adhesive tapes was measured using the recording papers. Based on the measurement values, a developing efficiency of each of the liquid developers was calculated and the calculated results were evaluated according to the following four criteria A to D. Here, the developing efficiency is defined by a value obtained by dividing the amount of the toner particles picked up from the photoreceptor by the sum of both the amount of the toner particles picked up from the photoreceptor and the amount of the toner particles picked up from the developing roller and further multiplying by 100.

A: Developing efficiency was 96% or higher, and the developing efficiency was very good.

B: Developing efficiency was 90% or higher but lower than 96%, and the developing efficiency was good.

C: Developing efficiency was 80% or higher but lower than 90%, and the developing efficiency was normal in practical use.

D: Developing efficiency was lower than 80%, and the developing efficiency was bad.

3.2 Transferring Efficiency

By using the image forming apparatus shown in FIG. 1 and in FIG. 2 a layer of the liquid developer was formed on the surface of the photoreceptor of the image apparatus using each of the liquid developers obtained in the Examples and the Comparative Examples. Next, the layer of the liquid developer formed on the outer peripheral surface of the photoreceptor was made to be passed between the photoreceptor and the intermediate transfer section so that the toner particles were transferred from the photoreceptor onto the intermediate transfer section. Then, the toner particles remaining on the outer peripheral surface of the photoreceptor and the toner particles transferred onto the outer peripheral surface of the intermediate transfer section were picked up by attaching adhesive tapes to the outer peripheral surface of the photoreceptor and the outer peripheral surface of the intermediate transfer section, respectively. Thereafter, the adhesive tapes carrying the toner particles were attached to recording papers so as to transfer the toner particles to each of the recording papers. And then, an amount of the toner particles attached to each of the adhesive tapes was measured using the recording papers. Based on the measurement values, a transferring efficiency was calculated and the calculated results were evaluated according to the following four criteria A to D. Here, the transferring efficiency is defined by a value obtained by dividing the amount of the toner particles picked up from the intermediate transfer section by the sum of both the amount of the toner particles picked up from the intermediate transfer section and the amount of the toner particles picked up from the photoreceptor and further multiplying by 100.

A: Transferring efficiency was 96% or higher, and the transferring efficiency was very good.

B: Transferring efficiency was 90% or higher but lower than 96%, and the transferring efficiency was good.

C: Transferring efficiency was 80% or higher but lower than 90%, and the transferring efficiency was normal in practical use.

D: Transferring efficiency was lower than 80%, and the transferring efficiency was bad.

3.3 Fixing Strength

By using the image forming apparatus shown in FIG. 1 and FIG. 2, images each having a predetermined pattern were formed on recording papers (High quality paper LPCPPA4 produced by Seiko Epson Corporation) using each of the liquid developers obtained in the Examples and the Comparative Examples, respectively. Then, the images formed on the papers were thermally fixed onto the papers at a fixing temperature of 100° C.

Then, after it was confirmed whether or not a non-offset area was present, the fixed image on each of the papers was rubbed out twice using a sand eraser (“LION 261-11”, Product of LION OFFICE PRODUCTS CORP.) with a pressure loading of 1.2 kgf. Then, the residual rate of the image density of each recording paper was measured by a colorimeter “X-Rite model 404” (X-Rite Incorporated), and the measurement results were evaluated according to the following five criteria A to E.

A: Residual rate of the image density was 96% or higher (very good).

B: Residual rate of the image density was 90% or higher but lower than 96% (good).

C: Residual rate of the image density was 80% or higher but lower than 90% (normal).

D: Residual rate of the image density was 70% or higher but lower than 80% (bad).

E: Residual rate of the image density was lower than 70% (very bad).

3.4 Positively Charge Property

Potential differences of the liquid developers of different colors obtained in the Examples and the Comparative Examples were measured by using a microscope type laser zeta potential meter (ZC-2000 produced by Microtec Nition Corporation), and the measurement results were evaluated according to the following five criteria A to E. In this regard, it is to be noted that zeta potential of each liquid developer was measured as follows.

First, each liquid developer was diluted with a dilution liquid, and then each diluted liquid developer was put in a transparent cell having diameters of 10×10 mm. Next, the transparent cell was set to the microscope type laser zeta potential meter, and then a voltage of 300 V was applied between electrodes (interval therebetween was 9 mm) of the microscope type laser zeta potential meter. At the same time, movement of the toner particles was observed with a microscope to calculate their moving speeds by the microscope type laser zeta potential meter, and zeta potential of each liquid developer was obtained based on the calculated moving speed values.

A: Potential difference was +100 mV or higher (very good).

B: Potential difference was +85 mV or higher but lower than +100 mV (good).

C: Potential difference was +70 mV or higher but lower than +85 mV (normal).

D: Potential difference was +50 mV or higher but lower than +70 mV (bad).

E: Potential difference was lower than +50 mV (very bad).

3.5 Dispersion Stability Test

3.5.1 Method 1

The liquid developer of 10 ml obtained in each of the Examples and the Comparative Examples was supplied to a test tube (bore diameter thereof was 12 mm, and length thereof was 120 mm). After the liquid developer in the test tube was placed in static condition for 10 days, a settling depth of the toner particles in each test tube was measured and the measured results were evaluated according to the following four criteria A to D.

A: Settling depth of toner particles was 0 mm.

B: Settling depth of toner particles was larger than 0 mm but 2 mm or lower.

C: Settling depth of toner particles was larger than 2 mm but 5 mm or lower.

D: Settling depth of toner particles was larger than 5 mm.

3.5.2 Method 2

The liquid developer of 45.5 ml obtained in each of the Examples and the Comparative Examples was supplied to a centrifugation tube. After the liquid developer was separated by a centrifugal machine (produced by KOKUSAN CORPORATION) under the conditions in which a radius of rotation was 5 cm, a rotation speed was changed to 500, 1,000, 2,000, 4,000, and 5,000 rpm, and a time was 3 minutes, a settling depth according to each of the rotation speeds (rpm) was measured.

Next, the values measured as described above were plotted with a centrifugal acceleration rω² (rω²=1118×radius of rotation (cm)×square of numbers of rotation per minute (rpm)²×10⁻⁸×g (acceleration of gravity)) as the horizontal axis and a settling depth as the vertical axis. Based on the plotted datum, a slope k of each of the liquid developers was calculated by the first approximation and calculated results were evaluated according to the following four criteria A to D. In this regard, the lower the value of the slope k becomes, the higher dispersion stability of the toner particles becomes.

A: 0≦k<0.004

B: 0.004≦k<0.008

C: 0.008≦k<0.012

D: k≧0.012

3.6 Recycle Property

By using the image forming apparatus shown in FIG. 1 and FIG. 2, images each having a predetermined pattern were formed on 10000 recording papers (High quality paper LPCPPA4 produced by Seiko Epson Corporation) using each of the liquid developers obtained in the Examples and the Comparative Examples, respectively. The image forming was performed in a state of stopping supplying the liquid developer from the liquid developer tank of each color to the stirring device corresponding to each color. After the image forming onto the 10000 recording papers is completed, the toner particles collected in the stirring device were diluted by the insulation liquid so that an amount of a solid matter became 20 mass %. By doing so, the recycled liquid developer (recycle liquid developer) was tested by the following two kinds of methods (Method 1 and Method 2). Thus, a possibility of the recycle (recycle property) was evaluated.

3.6.1 Method 1

The recycle liquid developer of 10 ml obtained in each of the Examples and the Comparative Examples was supplied to a test tube (bore diameter thereof was 12 mm, and length thereof was 120 mm). After the recycle liquid developer in the test tube was placed in static condition for 10 days, a settling depth of the toner particles in each test tube was measured and the measured results were evaluated according to the following four criteria A to D.

A: Settling depth of toner particles was 1 mm or less.

B: Settling depth of toner particles was larger than 1 mm but 3 mm or less.

C: Settling depth of toner particles was larger than 3 mm but 6 mm or less.

D: Settling depth of toner particles was larger than 6 mm.

3.6.2 Method 2

The recycle liquid developer of 45.5 ml obtained in each of the Examples and the Comparative Examples was supplied to a centrifugation tube. After the recycle liquid developer was separated by a centrifugal machine (produced by KOKUSAN CORPORATION) under the conditions in which a radius of rotation was 5 cm, a rotation speed was changed to 500, 1,000, 2,000, 4,000, and 5,000 rpm, and a time was 3 minutes, a settling depth according to each of the rotation speeds (rpm) was measured.

Next, the values measured as described above were plotted with a centrifugal acceleration rω² (rω²=1118×radius of rotation (cm)×square of numbers of rotation per minute (rpm)²×10⁻⁸×g (acceleration of gravity)) as the horizontal axis and a settling depth as the vertical axis. Based on the plotted datum, a slope k of each of the liquid developers was calculated by the first approximation and calculated results were evaluated according to the following four criteria A to D. In this regard, the lower the value of the slope k becomes, the higher dispersion stability of the toner particles becomes.

A: 0≦k<0.006

B: 0.006≦k<0.010

C: 0.010≦k<0.014

D: k≧0.014

These results are shown in Table 4 and Table 5.

TABLE 4

| | Grinding | Developing | Transferring | | Positively | Dispersion stability | | Recycle property | |
|---|---|---|---|---|---|---|---|---|---|
| | efficiency | efficiency | efficiency | Fixing strength | charge property | Method 1 | Method 2 | Method 1 | Method 2 |
| Ex. 1 | A | A | A | A | A | A | A | A | A |
| Ex. 2 | B | B | B | A | B | A | A | A | A |
| Ex. 3 | A | A | A | A | A | A | A | A | A |
| Ex. 4 | A | A | A | A | A | A | A | A | A |
| Ex. 5 | A | A | A | A | A | A | A | A | A |
| Ex. 6 | A | A | A | A | A | A | A | A | A |
| Ex. 7 | A | A | A | A | A | A | A | A | A |
| Ex. 8 | A | A | A | A | A | A | A | A | A |
| Ex. 9 | A | A | A | A | A | A | A | A | A |
| Ex. 10 | A | B | B | A | B | B | B | B | B |
| Ex. 11 | A | B | B | A | B | B | B | B | B |
| Ex. 12 | A | A | A | A | A | A | A | A | A |
| Ex. 13 | A | B | B | A | B | A | A | A | A |
| Ex. 14 | A | A | A | A | A | A | A | A | A |
| Ex. 15 | A | A | A | A | A | A | A | A | A |
| Ex. 16 | A | A | A | A | A | A | A | A | A |
| Ex. 17 | B | A | A | A | A | A | A | A | A |

TABLE 5

| | Grinding | Developing | Transferring | | Positively | Dispersion stability | | Recycle property | |
|---|---|---|---|---|---|---|---|---|---|
| | efficiency | efficiency | efficiency | Fixing strength | charge property | Method 1 | Method 2 | Method 1 | Method 2 |
| Ex. 18 | A | A | A | A | A | A | A | A | A |
| Ex. 19 | A | A | A | A | A | A | A | A | A |
| Ex. 20 | A | A | A | A | A | A | A | A | A |
| Ex. 21 | B | A | A | A | A | A | A | A | A |
| Ex. 22 | A | A | A | A | A | A | A | A | A |
| Ex. 23 | A | A | A | A | A | A | A | A | A |
| Ex. 24 | A | A | A | A | A | A | A | A | A |
| Ex. 25 | A | A | A | A | A | A | A | A | A |
| Com. Ex. 1 | A | C | C | B | C | B | B | B | B |
| Com. Ex. 2 | A | D | D | B | D | D | D | D | D |
| Com. Ex. 3 | A | C | C | B | C | B | B | B | B |
| Com. Ex. 4 | C | D | D | B | D | D | D | D | D |
| Com. Ex. 5 | D | D | D | B | D | D | D | D | D |
| Com. Ex. 6 | A | D | D | B | D | D | D | D | D |
| Com. Ex. 7 | A | D | D | B | D | D | D | D | D |
| Com. Ex. 8 | A | C | C | B | C | B | B | B | B |
| Com. Ex. 9 | D | D | D | B | D | D | D | D | D |
| Com. Ex. 10 | A | D | D | B | D | D | D | D | D |
| Com. Ex. 11 | A | D | D | B | D | D | D | D | D |
| Com. Ex. 12 | D | C | C | B | C | B | B | B | B |

As shown in the Table 4 and Table 5, the liquid developers according to the invention had the excellent charge property (positive charge property), the excellent dispersion stability of the toner particles for a long period of time and the excellent recycle property. Further, the liquid developers of the invention also had the excellent developing efficiency, excellent transferring efficiency and excellent fixing strength. In contrast, the liquid developers obtained in the Comparative Examples had insufficient results.

What is claimed is:

1. A method of producing a liquid developer containing an insulation liquid, toner particles, and a substance B, wherein the toner particles are constituted of a substance A and a toner material including a resin material and a coloring agent, and
wherein the resin material is a polyester resin and/or a styrene-acrylic resin, the substance A is an acrylic modified silicone sufficiently soluble to the insulation liquid and the substance B is a silanol group-containing polysiloxane and/or a fluorine modified silicone, the method comprising:
grinding the toner material under the presence of the substance A in the insulation liquid to obtain a dispersion liquid in which fine particles are dispersed;
subjecting the dispersion liquid to a heat treatment at a higher temperature than a glass transition temperature of the resin material while adding shear force to the dispersion liquid: and
mixing the dispersion liquid having been subjected to the heat treatment with the substance B to obtain the liquid developer containing the toner particles comprised of the fine particles.

2. A method of producing a liquid developer containing an insulation liquid, toner particles, and a substance B, wherein the toner particles are constituted of a substance A and a toner material including a resin material and a coloring agent, and
wherein the resin material is a polyester resin and/or a styrene-acrylic resin, the substance A is an acrylic modified silicone sufficiently soluble to the insulation liquid and the substance B is a silanol group-containing polysiloxane and/or a fluorine modified silicone, the method comprising:
grinding the toner material under the presence of the substance A and the substance B in the insulation liquid to obtain a dispersion liquid in which fine particles are dispersed; and
subjecting the dispersion liquid to a heat treatment at a higher temperature than a glass transition temperature of the resin material while adding shear force to the dispersion liquid to obtain the liquid developer containing the toner particles comprised of the fine particles.

3. The method as claimed in claim 1, wherein the substance A is an acrylic modified silicone in which radical polymerization monomers are copolymerized.

4. The method as claimed in claim 3, wherein the radical polymerization monomers have polar groups.

5. The method as claimed in claim 4, wherein the polar groups of the radical polymerization monomers are amino groups.

6. The method as claimed in claim 1, wherein the substance A is an acrylic modified silicone in which silicone macromeres represented by the following general formula (1) are copolymerized: 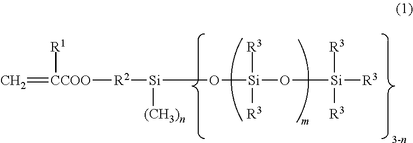
where R¹ is a hydrogen atom or a methyl group, R² is a bivalent hydrocarbon group having a carbon number in the range of 1 to 5, R³ is a hydrocarbon group having a carbon number in the range of 1 to 3, an aryl group or a fluorine-substituted hydrocarbon group having a carbon number in the range of 1 to 3 which are identical to or different from each other, n is an integer of 0 to 2, and m is an integer of 0 to 500.

7. The method as claimed in claim 1, wherein the grinding is performed by further using at least one selected from the group consisting of a quaternary cation silicone, an amino phenyl modified silicone and a phenyl modified silicone.

8. The method as claimed in claim 1, wherein an amount of the substance A contained in the finally obtained liquid developer is in the range of 0.1 mass % or more but 10.0 mass % or less.

9. The method as claimed in claim 1, wherein an amount of the substance B contained in the finally obtained liquid developer is in the range of 0.1 mass % or more but 12.5 mass % or less.

10. A liquid developer comprising:
an insulation liquid;
toner particles constituted of base particles including a resin material and a coloring agent and a substance A adhering to the base particles; and
a substance B;
wherein the resin material is at least one of a polyester resin and a styrene-acrylic resin, and wherein the substance A is an acrylic modified silicone sufficiently soluble to the insulation liquid and the substance B is at least one of a silanol group-containing polysiloxane and a fluorine modified silicone.
